(19) United States
(12) Patent Application Publication
(10) Pub. No.: US 2025/0285581 A1
(43) Pub. Date: Sep. 11, 2025

(54) DISPLAY DRIVING CIRCUIT AND DISPLAY DEVICE

(71) Applicant: Yungu (Gu’an) Technology Co., Ltd., Langfang (CN)

(72) Inventors: Lei MI, Langfang (CN); Hongrui LI, Langfang (CN); Jianjun LU, Langfang (CN); Caiyan TANG, Langfang (CN)

(73) Assignee: Yungu (Gu’an) Technology Co., Ltd., Langfang (CN)

(21) Appl. No.: 19/216,716

(22) Filed: May 23, 2025

Related U.S. Application Data
(63) Continuation of application No. PCT/CN2023/090532, filed on Apr. 25, 2023.

(30) Foreign Application Priority Data
Nov. 29, 2022 (CN) 202211516882.8

(51) Int. Cl. G09G 3/32

(52) U.S. Cl. CPC G09G 3/32; G09G 2300/0842; G09G 2310/0286; G09G 2310/08; G09G 2340/0435

(57) ABSTRACT

The present application discloses a display driving circuit and a display device. The display driving circuit includes: a first scan driving circuit, including: a plurality of first shift registers arranged in cascade, and at least one first cascade control module. The first shift register includes a first register input terminal and a first register output terminal. The first cascade control module includes a first cascade control unit and a signal transfer unit, where the first cascade control unit is configured to control a connection state between a current-stage first register output terminal and a next-stage first register input terminal. An output terminal of the signal transfer unit is electrically connected to a next-stage first register input terminal; and the signal transfer unit is configured to transmit a start control signal to the next-stage first register input terminal in response to a transfer control signal.

### CROSS-REFERENCE TO RELATED APPLICATIONS

The present application is a continuation of International Application No. PCT/CN2023/090532 filed on Apr. 25, 2023, which claims priority to Chinese Patent Application No. 202211516882.8 filed with the China National Intellectual Property Administration on Nov. 29, 2022. All of the aforementioned patent applications are hereby incorporated by reference in their entireties.

### FIELD

The present application relates to the field of display technologies and, for example, to a display driving circuit and a display device.

### BACKGROUND

With the development of display technologies, the application scenarios of display panels are becoming increasingly diversified, and users' display requirements for display panels are also becoming more varied. The full-screen switching frequency technology in the related art can no longer meet users' demands for displaying a plurality of scenarios within a single screen on a terminal product. The display driving circuit design in the related art does not account for the requirements of partitioned multi-frequency driving, and thus cannot support display with a plurality of refresh frequencies across a plurality of partitions within a single screen.

### SUMMARY

The present application provides a display driving circuit and a display device to enable a display panel to have a partitioned multi-frequency display function, thereby achieving real-time switching between a plurality of frequencies across different regions within a single screen.

The embodiments of the present application provide the following solutions.

A display driving circuit, including: a first scan driving circuit,
the first scan driving circuit including:
a plurality of first shift registers arranged in cascade, the first shift register including a first register input terminal and a first register output terminal; and
at least one first cascade control module,
one of the at least one first cascade control module including a first cascade control unit, where the first cascade control unit is connected between two of the first shift registers,
the two of the first shift registers comprise a current-stage first shift register and a next-stage first shift register, the current-stage first shift register comprise a current-stage first register output terminal, the next-stage first shift register comprise a next-stage first register input terminal; and the first cascade control unit is configured to control a connection state between the current-stage first register output terminal and the next-stage first register input terminal; and
the one of the at least one first cascade control module further including a signal transfer unit, where a control terminal of the signal transfer unit is applied a transfer control signal, an input terminal of the signal transfer unit is applied a start control signal, and an output terminal of the signal transfer unit is electrically connected to the next-stage first register input terminal; and the signal transfer unit is configured to transmit the start control signal to the next-stage first register input terminal in response to the transfer control signal.

In one embodiment, the start control signal includes: a reference signal having fixed potential; and the signal transfer unit is configured to transmit the reference signal to the next-stage first register input terminal in response to the transfer control signal.

In one embodiment, the start control signal includes: a pulse signal, the control terminal of the signal transfer unit is electrically connected to the input terminal of the signal transfer unit, and the transfer control signal is reused as the start control signal.

In one embodiment, the first cascade control unit includes a first switch sub-unit, a control terminal of the first switch sub-unit being connected to a first switch signal, a first terminal of the first switch sub-unit being electrically connected to the current-stage first register output terminal, and a second terminal of the first switch sub-unit being electrically connected to the next-stage first register input terminal, where the transfer control signal and the first switch signal are opposite in phase; and the start control signal includes: a pulse signal, and the signal transfer unit is configured to transmit the pulse signal to the next-stage first register input terminal in response to the transfer control signal.

In one embodiment, the current-stage first shift register and the next-stage first shift register are respectively an i^{th}-stage first shift register and an (i+a)^{th}-stage first shift register, where i and a are both positive integers, where
in a case where the i^{th}-stage first shift register outputs cutoff potential of an i^{th}-stage scan signal and the (i+a)^{th}-stage first shift register outputs turn-on potential of an (i+a)^{th}-stage scan signal, during a phase when the i^{th}-stage first shift register outputs the cutoff potential of the i^{th}-stage scan signal, the first cascade control unit cuts off a connection between the i^{th}-stage first shift register and the (i+a)^{th}-stage first shift register, and the signal transfer unit transmits the start control signal to the (i+a)^{th}-stage first register input terminal in response to the transfer control signal; and
in a case where the i^{th}-stage first shift register outputs turn-on potential of the i^{th}-stage scan signal and the (i+a)^{th}-stage first shift register outputs cutoff potential of the (i+a)^{th}-stage scan signal, during a phase when the i^{th}-stage first shift register outputs the turn-on potential of the i^{th}-stage scan signal, the first cascade control unit cuts off the connection between the i^{th}-stage first shift register and the (i+a)^{th}-stage first shift register, and the signal transfer unit is turned off in response to the transfer control signal.

In one embodiment, the first cascade control unit in one first cascade control module is connected between an m^{th}-stage first shift register and an (m+a)^{th}-stage first shift register, where m and a are both positive integers; and the (m+a)^{th}-stage first shift register is a next-stage first shift register corresponding to the m^{th}-stage first shift register; and
the first scan driving circuit further includes at least one second cascade control module,
the second cascade control module including a second cascade control unit, with one second cascade control unit being connected between a k^{th}-stage first shift register and a (k+a)^{th}-stage first shift register, where k is a positive integer less than m, and the (k+a)^{th}stage first shift register is a next-stage first shift register corresponding to the k^{th}-stage first shift register.

In one embodiment, a partition position for reduced-frequency display of the display panel is determined based on a position where the second cascade control module is provided; and a partition position for increased-frequency display of the display panel is determined based on a position where the first cascade control module is provided.

In one embodiment, the signal transfer unit includes: a first transistor, where a gate of the first transistor is connected to the transfer control signal, a first electrode of the first transistor is connected to the start control signal, and a second electrode of the first transistor is electrically connected to an (m+a)^{th}-stage first register input terminal; and
the first cascade control unit includes a first switch sub-unit, the first switch sub-unit including a second transistor, where a gate of the second transistor is connected to a first switch signal, a first electrode of the second transistor is electrically connected to an m^{th}-stage first register output terminal, and a second electrode of the second transistor is electrically connected to the (m+a)^{th}-stage first register input terminal.

In one embodiment, in a case where the m^{th}-stage first shift register outputs cutoff potential of an m^{th}-stage scan signal and the (m+a)^{th}-stage first shift register outputs turn-on potential of an (m+a)^{th}-stage scan signal,
during a phase when the m^{th}-stage first shift register outputs the cutoff potential of the m^{th} -stage scan signal, the second transistor disconnects the m^{th}-stage first register output terminal from the (m+a)^{th}-stage first register input terminal in response to the first switch signal, and the first transistor transmits the start control signal to the (m+a)^{th}-stage first register input terminal in response to the transfer control signal.

In one embodiment, the first cascade control unit further includes a second switch sub-unit, the second switch sub-unit including a third transistor, where a gate of the third transistor is connected to a second switch signal, a first electrode of the third transistor is connected to an auxiliary turn-off signal, and a second electrode of the third transistor is electrically connected to the (m+a)^{th}-stage first register input terminal; and
in a case where the m^{th}-stage first shift register outputs cutoff potential of an m^{th}-stage scan signal and the (m+a)^{th}-stage first shift register outputs turn-on potential of an (m+a)^{th}-stage scan signal, during a phase when the m^{th}-stage first shift register outputs the cutoff potential of the m^{th}-stage scan signal, the third transistor disconnects the auxiliary turn-off signal from the (m+a)^{th}-stage first register input terminal in response to the second switch signal.

In one embodiment, the second cascade control unit includes a third switch sub-unit, the third switch sub-unit including a fourth transistor, where a gate of the fourth transistor is connected to a third switch signal, a first electrode of the fourth transistor is electrically connected to a k^{th}-stage first register output terminal, and a second electrode of the fourth transistor is electrically connected to a (k+a)^{th}-stage first register input terminal; and
the second cascade control unit further includes a fourth switch sub-unit, the fourth switch sub-unit including a fifth transistor, where a gate of the fifth transistor is connected to a fourth switch signal, a first electrode of the fifth transistor is connected to an auxiliary turn-off signal, and a second electrode of the fifth transistor is electrically connected to the (k+a)^{th}-stage first register input terminal.

In one embodiment, in a case where the k^{th}-stage first shift register outputs turn-on potential of a k^{th}-stage scan signal and the (k+a)^{th}-stage first shift register outputs cutoff potential of a (k+a)^{th}-stage scan signal,
during a phase when the k^{th}-stage first shift register outputs the turn-on potential of the k^{th}-stage scan signal, the fourth transistor disconnects the k^{th}-stage first register output terminal from the (k+a)^{th}-stage first register input terminal in response to the third switch signal, and the fifth transistor transmits the auxiliary turn-off signal to the (k+a)^{th}-stage first register input terminal in response to the fourth switch signal.

In one embodiment, the first switch signal is reused as the third switch signal, and the transfer control signal is reused as the fourth switch signal; or
the first cascade control unit further includes a second switch sub-unit, the second switch sub-unit including a third transistor, where a gate of the third transistor is connected to a second switch signal, a first electrode of the third transistor is connected to the auxiliary turn-off signal, and a second electrode of the third transistor is electrically connected to the (m+a)^{th}-stage first register input terminal; and
the first switch signal is reused as the third switch signal, and the second switch signal is reused as the fourth switch signal;

In one embodiment, the at least one first cascade control module includes a plurality of first cascade control modules, and the first cascade control module includes a signal transfer unit, where the first cascade control module is disposed between two corresponding first shift registers among at least part of the first shift registers; and
a partition position for increased-frequency display is determined based on jump time of the transfer control signal.

In one embodiment, the first scan driving circuit further includes: a plurality of second shift registers arranged in cascade, where at least part of the second shift registers are arranged respectively corresponding to the at least part of the first shift registers; and the second shift register includes: a second register input terminal and a second register output terminal, where
an input terminal of the signal transfer unit is electrically connected to a corresponding second register output terminal among the at least part of the second shift registers, and a corresponding start control signal is output to the input terminal of the corresponding signal transfer unit through the second register output terminal among the at least part of the second shift registers;
the second shift registers are arranged respectively corresponding to the first shift registers; and a first-stage first register input terminal and a first-stage second register input terminal are both connected to a scan input signal; and
each of the signal transfer units is turned on in response to the same transfer control signal, and a pulse width of the transfer control signal is greater than or equal to that of an output signal of each of the second shift registers.

In one embodiment, the second shift register includes: a sixth transistor, a seventh transistor, and an eighth transistor, where a gate of the sixth transistor is electrically connected to a first clock terminal of the second shift register, a first electrode of the sixth transistor is electrically connected to the second register input terminal, and a second electrode of the sixth transistor is electrically connected to a gate of the seventh transistor, a first electrode of the seventh transistor is electrically connected to a second clock terminal of the second shift register, and a second electrode of the seventh transistor is electrically connected to the second register output terminal, and a gate of the eighth transistor is electrically connected to the first clock terminal of the second shift register, a first electrode of the eighth transistor is electrically connected to the second register output terminal, and a second electrode of the eighth transistor is connected to a first potential signal.

In one embodiment, the second shift register further includes: a first capacitor and a second capacitor, where the first capacitor is connected between the gate and the second electrode of the seventh transistor, a first terminal of the second capacitor is connected to the first potential signal, and a second terminal of the second capacitor is electrically connected to the second register output terminal.

In one embodiment, the second shift register further includes: a ninth transistor, where a first electrode of the ninth transistor is connected to the first potential signal, a second electrode of the ninth transistor is electrically connected to the second register output terminal, and in a case where the second electrode of the ninth transistor is electrically connected to an n^{th}-stage second register output terminal, a gate of the ninth transistor is electrically connected to an (n+2a)^{th}-stage second register output terminal, where n is a positive integer.

In one embodiment, the signal transfer units are all turned on in response to the same transfer control signal;
the first cascade control module includes a first cascade control unit, where the first cascade control unit includes a first switch sub-unit, the first switch sub-units including second transistors, where gates of the second transistors are all connected to the same first switch signal, first electrodes of the second transistors are electrically connected to corresponding current-stage first register output terminals, and second electrodes of the second transistors are electrically connected to corresponding next-stage first register input terminals;
the first cascade control units further include second switch sub-units, the second switch sub-units including third transistors, where gates of the third transistors are all connected to the same second switch signal, first electrodes of the third transistors are all connected to the same auxiliary turn-off signal, and second electrodes of the third transistors are electrically connected to corresponding next-stage first register input terminals; and
the signal transfer unit includes: first transistors, where gates of the first transistors are all connected to the same transfer control signal, first electrodes of the first transistors are connected to corresponding start control signals, and second electrodes of the first transistors are electrically connected to corresponding next-stage first register input terminals.

In one embodiment, in a case where the first switch signal controls the second transistor to be turned on and the second switch signal controls the third transistor to be turned off, the transfer control signal controls the first transistor to be turned off, so that the first transistor does not transmit a corresponding start control signal to a next-stage first register input terminal corresponding to the first transistor, and a current-stage first register output terminal corresponding to the second transistor is electrically connected to the next-stage first register input terminal;
in a case where the first switch signal controls the second transistor to be turned off and the second switch signal controls the third transistor to be turned on, the transfer control signal controls the first transistor to be turned off, so that the first transistor does not transmit the start control signal to the next-stage first register input terminal corresponding to the first transistor, and the auxiliary turn-off signal is transmitted to a next-stage first register input terminal corresponding to the third transistor; and
in a case where the first switch signal controls the second transistor to be turned off and the second switch signal controls the third transistor to be turned off, the transfer control signal controls the first transistor to be turned on, and the first transistor outputs the corresponding start control signal to the next-stage first register input terminal corresponding to the first transistor.

In one embodiment, the display driving circuit further includes: a plurality of pixel driver circuits and a plurality of first scan lines, where the plurality of pixel driver circuits are arranged in an array, and each row of pixel driver circuits is electrically connected to at least one of the plurality of first scan lines; and first register output terminals in the first scan driving circuit are electrically connected to the first scan lines; the pixel driver circuit includes: a driving module, a data writing module, a threshold compensation module, and a light emission control module, where
the driving module is connected between the light emission control module and a light-emitting device, and the driving module is configured to generate a driving current; the data writing module is electrically connected to a first terminal of the driving module, and the data writing module is configured to transmit a data voltage to the driving module; the threshold compensation module is connected between a control terminal and a second terminal of the driving module, and the threshold compensation module is configured to compensate for a threshold voltage of the driving module; and the first scan line is electrically connected to control terminals of threshold compensation modules in a corresponding row of pixel driver circuits; and
the pixel driver circuit further includes: a first reset module electrically connected to the control terminal of the driving module, the first reset module being configured to reset the control terminal of the driving module; and the display driving circuit further includes: a plurality of second scan lines, the second scan lines being electrically connected to control terminals of first reset modules in corresponding rows of pixel driver circuits, where
first register output terminals in the first scan driving circuit are electrically connected to the second scan lines, where a second scan line connected to a j^{th}row of pixel driver circuits is electrically connected to a j^{th}-stage first register output terminal, and a first scan line connected to the j^{th} row of pixel driver circuits is electrically connected to a (j+b)^{th}-stage first register output terminal, where j and b are both positive integers.

In one embodiment, the signal transfer unit includes: a first transistor, where a gate of the first transistor is connected to the transfer control signal, a first electrode of the first transistor is connected to the start control signal, and a second electrode of the first transistor is electrically connected to a corresponding next-stage first register input terminal; and
the first cascade control unit includes a first switch sub-unit, the first switch sub-unit including a second transistor, where a gate of the second transistor is connected to a first switch signal, a first electrode of the second transistor is electrically connected to a corresponding current-stage first register output terminal, and a second electrode of the second transistor is electrically connected to a corresponding next-stage first register input terminal;
the first cascade control unit further includes a second switch sub-unit, the second switch sub-unit including a third transistor, where a gate of the third transistor is connected to a second switch signal, a first electrode of the third transistor is connected to an auxiliary turn-off signal, and a second electrode of the third transistor is electrically connected to a corresponding next-stage first register input terminal.

Correspondingly, the present application further provides a display device, including: a display driving circuit according to any embodiment of the present application.

With the display driving circuit according to the embodiments of the present application, driving of partitioned multi-frequency display of the display panel in a sub-pixel column direction can be implemented by arranging a first cascade control module in the first scan driving circuit. The first cascade control unit in the first cascade control module is configured to control whether the scan signal output by the first shift register can be propagated stage by stage. By cutting off the transmission of the scan signal to the next-stage first shift register, a driving scheme for partitioned display within the same frame of display with the refresh frequency transitioning from high to low can be implemented. Additionally, the signal transfer unit in the first cascade control module provides a start signal to the next-stage first shift register again based on the transfer control signal and the start control signal, causing the next-stage first shift register to output the turn-on potential of the scan signal again and enabling continue stage-by-stage transmission of the turn-on potential, thereby implementing the driving scheme for partitioned display within the same frame of display with the refresh frequency transitioning from low to high. In summary, compared to the related art, the embodiments of the present application enable the display panel to possess a partitioned multi-frequency display capability, thereby achieving real-time switching between a plurality of frequencies across different regions within a single screen and allowing free switching of the refresh frequency between high and low.

### BRIEF DESCRIPTION OF THE DRAWINGS

FIG. 1 is a schematic diagram of a structure of a display panel in the related art;

FIG. 2 is a comparative schematic diagram of the composition of display frames under different refresh frequencies in the related art;

FIG. 3 is a schematic diagram of a structure of a display driving circuit according to an embodiment of the present application;

FIG. 4 is a schematic diagram of a structure of another display driving circuit according to an embodiment of the present application;

FIG. 5 is a schematic diagram of a structure of a further display driving circuit according to an embodiment of the present application;

FIG. 6 is a schematic diagram of a structure of a display panel according to an embodiment of the present application;

FIG. 7 is a timing diagram of driving signals for a display frame according to an embodiment of the present application;

FIG. 8 is a timing diagram of driving signals for another display frame according to an embodiment of the present application;

FIG. 9 is a timing diagram of driving signals for a further display frame according to an embodiment of the present application;

FIG. 10 is a schematic diagram of a driving timing sequence of a display panel according to an embodiment of the present application;

FIG. 11 is a schematic diagram of a driving timing sequence of another display

panel according to an embodiment of the present application;

FIG. 12 is a schematic diagram of a structure of a further display driving circuit according to an embodiment of the present application;

FIG. 13 is a schematic diagram of a structure of another display panel according to an embodiment of the present application;

FIG. 14 is a schematic diagram of a driving timing sequence of a further display panel according to an embodiment of the present application;

FIG. 15 is a schematic diagram of a structure of a further display driving circuit according to an embodiment of the present application;

FIG. 16 is a schematic diagram of a structure of a further display driving circuit according to an embodiment of the present application;

FIG. 17 is a timing diagram of driving signals for a further display frame according to an embodiment of the present application;

FIG. 18 is a timing diagram of driving signals for a further display frame according to an embodiment of the present application;

FIG. 19 is a timing diagram of driving signals for a further display frame according to an embodiment of the present application;

FIG. 20 is a simulation waveform diagram of a driving process of a display driving circuit according to an embodiment of the present application;

FIG. 21 is a schematic diagram of a structure of a second shift register according to an embodiment of the present application;

FIG. 22 is a schematic diagram of a structure of a 1^{st}-stage second shift register according to an embodiment of the present application;

FIG. 23 is a schematic diagram of a driving timing sequence of a second shift register according to an embodiment of the present application;

FIG. 24 is a schematic diagram of a structure of another second shift register according to an embodiment of the present application;

FIG. 25 is a simulation waveform diagram of a driving process of a second shift register according to an embodiment of the present application;

FIG. 26 is a simulation waveform diagram of a driving process of another second shift register according to an embodiment of the present application;

FIG. 27 is a schematic diagram of a structure of a further second shift register according to an embodiment of the present application;

FIG. 28 is a simulation waveform diagram of a driving process of a further second shift register according to an embodiment of the present application;

FIG. 29 is a schematic diagram of a structure of a shift register according to an embodiment of the present application;

FIG. 30 is a schematic diagram of a driving timing sequence of a shift register according to an embodiment of the present application;

FIG. 31 is a schematic diagram of a structure of a pixel driver circuit according to an embodiment of the present application;

FIG. 32 is a schematic diagram of a driving timing sequence of a pixel driver circuit according to an embodiment of the present application;

FIG. 33 is a schematic diagram of a structure of a further display panel according to an embodiment of the present application;

FIG. 34 is a schematic diagram of a structure of another pixel driver circuit according to an embodiment of the present application;

FIG. 35 is a schematic diagram of a driving timing sequence of another pixel driver circuit according to an embodiment of the present application;

FIG. 36 is a schematic diagram of a structure of another shift register according to an embodiment of the present application;

FIG. 37 is a schematic diagram of a driving timing sequence of another shift register according to an embodiment of the present application; and

FIG. 38 is a schematic diagram of a driving timing sequence of a further pixel driver circuit according to an embodiment of the present application.

### DETAILED DESCRIPTION OF THE EMBODIMENTS

It should be noted that the terms such as “first” and “second” in the specification and the claims of the present application and in the aforementioned accompanying drawings are used to distinguish similar objects, and do not necessarily describe a specific order or sequence. It should be understood that the data used in this way can be interchanged where appropriate, such that the embodiments of the present application described herein can be implemented in a sequence other than those illustrated or described herein. In addition, the terms “comprising/including” and “having,” as well as any variations thereof, are intended to cover non-exclusive inclusion.

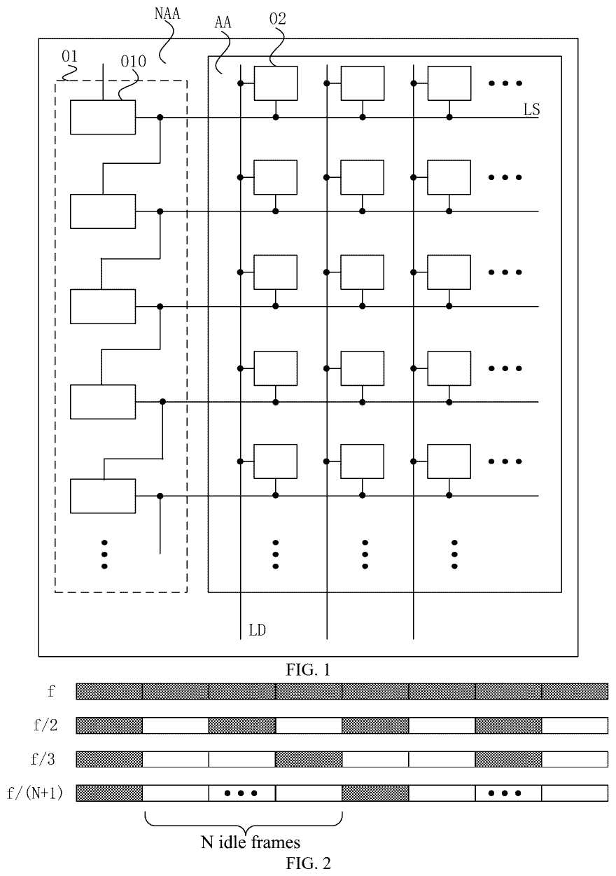

In pursuit of better user experience, the display industry has been continuously striving for higher picture quality, with screen refresh frequencies repeatedly reaching new heights. Currently, the refresh frequency of mobile phone products has exceeded 165 Hz. In addition, low-frequency display has also been making breakthroughs. The Low Temperature Polycrystalline Oxide (LTPO) technology, which achieves a refresh frequency of 1 Hz, has already been mass-produced, leading to continuous reductions in screen power consumption. Moreover, mobile phone products in the related art already support dynamic refresh frequencies, enabling simultaneous frequency switching on the entire screen. On this basis, a certain balance between image display quality and screen power consumption is achieved. With combined reference to FIGS. 1 and 2, the structure and driving process of the display panel in the related art are briefly described below.

FIG. 1 is a schematic diagram of a structure of a display panel in the related art. With reference to FIG. 1, the display panel includes an active area (AA) and a non-active area (NAA). The display driving circuit in the display panel includes: a scan driving circuit 01 arranged in the non-active area NAA and pixel driver circuits 02 arranged in an array in the active area AA. The scan driving circuit 01 includes shift registers 010 arranged in cascade, and the scan driving circuit 01 can operate in a single-side driving mode or a dual-side driving mode. The pixel driver circuit 02, together with a light-emitting device, forms one sub-pixel. Each sub-pixel serves as one smallest display unit, and a plurality of sub-pixels of different colors form one pixel, thereby enabling color display. Each stage of shift register 010 is correspondingly connected to one scan line LS and provides a scan signal to a corresponding row of sub-pixels through the scan line LS, while each column of sub-pixels is correspondingly connected to one data line LD.

During an image display process, data writing is performed on each pixel driver circuit 02 by means of row-by-row scanning. That is, the shift register 010 provides scan signals to the pixel driver circuits 02 through the scan line LS. Corresponding to the duration of turn-on potential of the scan signal, a data voltage on the data line LD is transmitted to the corresponding pixel driver circuit 02 to achieve data writing, and each sub-pixel displays based on the data voltage. When the scan line LS provides cutoff potential, the data voltage on the data line LD cannot be transmitted to the corresponding pixel driver circuit 02, and no data writing is performed. For example, when scanning the 1^{st} row of sub-pixels, the scan line LS corresponding to the 1^{st} row of sub-pixels provides turn-on potential to the 1^{st} row of pixel driver circuits 02, while the scan lines LS corresponding to the other rows of sub-pixels provide cutoff potential, so that data voltages on the data lines LD are transmitted to the 1^{st} row of sub-pixels. At any given time, only one shift register 010 outputs the turn-on potential of the scan signal.

For a display panel capable of switching display frequencies, the display frames of the sub-pixel can be divided into active frames and idle frames. In an active frame, the shift register 010 provides turn-on potential to the pixel driver circuits 02, causing the data voltage to be written into the pixel driver circuits 02; and in an idle frame, the shift register 010 provides cutoff potential to the pixel driver circuits 02, and the pixel driver circuits 02 do not perform data writing.

The refresh frequency can be understood as the number of active frames contained in a unit of time. By way of example, only active frames may be included in high-frequency display. With reference to FIG. 2, an active frame is represented by a shade-filled box, and an idle frame is represented by a blank box. The implementation of low-frequency refreshing is as follows. Under a conventional refresh frequency f, the display frame of the display panel consists only of active frames. By way of example, when f=60 Hz, the display panel refreshes 60 display frames within 1 second, with each frame duration=1s/60=16.67 ms. When the refresh frequency decreases, idle frames are inserted between adjacent active frames, while the number of display frames in a unit of time remains unchanged, and the display duration of each display frame also remains unchanged. When the refresh frequency is f/2, one idle frame is inserted between every two adjacent active frames, that is, odd-numbered frames are active frames, and even-numbered frames are idle frames. When the refresh frequency is f/3, two idle frames are inserted between every two adjacent active frames. By analogy, when the refresh frequency is f/(N+1), N idle frames are inserted between every two adjacent active frames.

In the display panel of the related art, by adjusting the input signal provided to the 1^{st}-stage shift register 010, whether each stage of shift register 010 outputs the turn-on potential of the scan signal is controlled, thereby achieving full-screen frequency switching. Furthermore, since the shift registers 010 in the scan driving circuit 01 are directly cascaded, the related art can only make all shift registers 010 either output the turn-on potential or output no turn-on potential within one frame of display, resulting in only one refresh frequency existing within one frame of display. Thus, only full-screen frequency switching can be achieved, and partitioned multi-frequency display cannot be achieved. However, as described in the Background Art, for products such as mobile phones and laptop computers, there is now a demand for a plurality of display scenarios within a single screen. The full-screen frequency switching technology cannot meet such scenarios, necessitating the development of a technology that enables real-time switching between a plurality of frequencies across different regions within the screen.

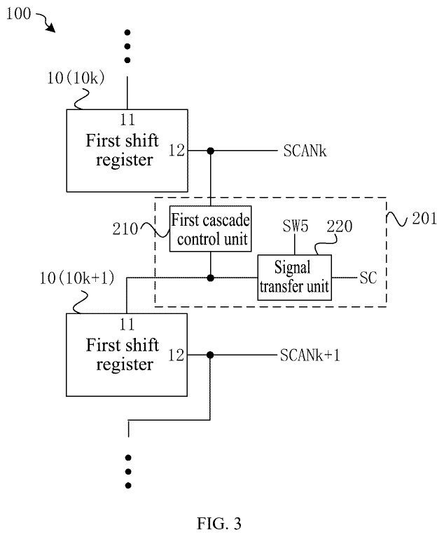

An embodiment of the present application provides a display driving circuit to implement a driving scheme for supplying different refresh frequencies to different display regions of the display panel, with the refresh frequency of each display region being adjustable. FIG. 3 is a schematic diagram of a structure of a display driving circuit according to an embodiment of the present application. With reference to FIG. 3, the display driving circuit includes: a first scan driving circuit 100. The first scan driving circuit 100 includes: a plurality of first shift registers 10 arranged in cascade, and at least one first cascade control module 201. The first shift register 10 includes a first register input terminal 11 and a first register output terminal 12. Each first cascade control module 201 may include a first cascade control unit 210 and a signal transfer unit 220. The first cascade control unit 210 is connected between two stages of first shift registers 10; and the first cascade control unit 210 is configured to control a connection state (e.g., connected or not connected) between a current-stage first register output terminal 12 and a next-stage first register input terminal 11. A control terminal of the signal transfer unit 220 is connected to a transfer control signal SW5, an input terminal of the signal transfer unit 220 is connected to a start control signal SC, and an output terminal of the signal transfer unit 220 is electrically connected to the next-stage first register input terminal 11; and the signal transfer unit 220 is configured to transmit the start control signal SC to the next-stage first register input terminal in response to the transfer control signal SW5.

It can be understood that when the stages of first shift registers 10 are connected in cascade, during the process of the first shift registers 10 outputting the scan signal stage by stage, the turn-on potential of the current-stage scan signal is transmitted to the next-stage first shift register 10, serving as the start signal for the next-stage first shift register 10 to trigger continued outputting of the turn-on potential of the scan signal from the next-stage first shift register 10, thereby achieving sequential shifting of the turn-on pulse of the scan signal.

It should be noted that the current-stage first shift register and the next-stage first shift register are respectively the i^{th}-stage first shift register and the (i+a)^{th}-stage first shift register in the first scan driving circuit 100, where i and a are both positive integers. By way of example, when the stages of first shift registers are cascaded in sequence, a=1, and when the current-stage first shift register is the 1^{st}-stage first shift register, the next-stage first shift register is the 2^{nd}-stage first shift register. In contrast, when the stages of shift registers are not cascaded in sequence, a>1, and the next-stage first shift register is not the immediate next stage of first shift register to the current-stage first shift register. For example, when a=2, odd-numbered-stage first shift registers are cascaded in sequence, and even-numbered-stage first shift registers are cascaded in sequence. When the current-stage first shift register is the 1^{st}-stage first shift register, the next-stage first shift register is the 3^{rd}-stage first shift register.

By way of example, in a case where the i^{th}-stage first shift register outputs cutoff potential of an i^{th}-stage scan signal and the (i+a)^{th}-stage first shift register outputs turn-on potential of an (i+a)^{th}-stage scan signal, that is, when increased-frequency display is required, during a phase when the i^{th}-stage first shift register outputs the cutoff potential of the i^{th}-stage scan signal, the first cascade control unit 210 cuts off a connection between the i^{th}-stage first shift register and the (i+a)^{th}-stage first shift register, and the signal transfer unit 220 transmits the start control signal SC to the (i+a)^{th}-stage first register input terminal in response to the transfer control signal SW5.

In a case where the i^{th}-stage first shift register outputs turn-on potential of the i^{th}-stage scan signal and the (i+a)^{th}-stage first shift register outputs cutoff potential of the (i+a)^{th}-stage scan signal, that is, when reduced-frequency display is required, during a phase when the i^{th}-stage first shift register outputs the turn-on potential of the i^{th}-stage scan signal, the first cascade control unit 210 cuts off the connection between the i^{th}-stage first shift register and the (i+a)^{th}-stage first shift register, and the signal transfer unit 220 is turned off in response to the transfer control signal SW5.

With the aforementioned embodiments, driving of partitioned multi-frequency display of the display panel in the sub-pixel column direction can be implemented by arranging the first cascade control module 201 in the first scan driving circuit 100. By way of example, the first cascade control unit 210 in the first cascade control module 201 is configured to control whether the scan signal output by the first shift register 10 can be propagated stage by stage. By cutting off the transmission of the scan signal to the next-stage first shift register 10, a driving scheme for partitioned display within the same frame of display with the refresh frequency transitioning from high to low can be implemented. Additionally, the signal transfer unit 220 in the first cascade control module 201 provides a start signal to the next-stage first shift register 10 again based on the transfer control signal SW5 and the start control signal SC, causing the next-stage first shift register 10 to output the turn-on potential of the scan signal again and enabling continue stage-by-stage transmission of the turn-on potential, thereby implementing the driving scheme for partitioned display within the same frame of display with the refresh frequency transitioning from low to high. In summary, compared to the related art, the embodiments of the present application enable the display panel to possess a partitioned multi-frequency display capability, thereby achieving real-time switching between a plurality of frequencies across different regions within a single screen and allowing free switching of the refresh frequency between high and low.

The embodiments of the present application are described below clearly and comprehensively with reference to the accompanying drawings in the embodiments of the present application. It should be noted that, in the following embodiments, for case of explanation, the connection structure in which the stages of first shift registers are cascaded in sequence will be used as an example for detailed explanation.

It should also be noted that, in the display panel, when the corresponding connection relationships for the scan driving circuits and the pixel driver circuits in the display panel are different, the sub-pixel row correspondingly connected to the i^{th}-stage first shift register 10 may be the i^{th} row of sub-pixels, or the (i−1)^{th} row of sub-pixels, or it may be another row of sub-pixels determined based on the connection relationship. In the following description process, for the convenience of explaining the operational process of the display driving circuit, the case where the i^{th}-stage first shift register 10 is correspondingly connected to the i^{th} row of sub-pixels will be taken as an example for illustration.

For a display panel provided with this first scan driving circuit 100, the position where the first cascade control unit 210 is provided and the position where the signal transfer unit 220 is provided can determine the partition position for reduced-frequency display and the partition position for increased-frequency display of the display panel. The analysis is as follows.

When each first cascade control unit 210 controls the current-stage first register output terminal 12 and the next-stage first register input terminal 11 to be connected, and the transfer control signal SW5 controls each signal transfer unit 220 to be turned off, all stages of first shift registers 10 achieve stage-by-stage cascading. This can enable the stage-by-stage shifting output of the turn-on potential of the scan signal, causing all rows of sub-pixels in the display panel to be in an active frame.

When the first cascade control unit 210 in a certain first cascade control module 201 controls the current-stage first register output terminal 12 and the next-stage first register input terminal 11 to be not connected, and the signal transfer unit 220 in the first cascade control module 201 is turned off, the display panel can achieve reduced-frequency display at the corresponding position of the first cascade control module 201. Taking the first cascade control module 201 between the k^{th}-stage first shift register 10k and the (k+1)^{th}-stage first shift register 10k+1 as an example, when the first cascade control unit 210 in the first cascade control module 201 controls the k^{th}-stage first register output terminal to be disconnected from the (k+1)^{th}-stage first register input terminal, when the scan signal SCANk output by the k^{th}-stage first shift register 10k in the current frame of display contains turn-on potential, the turn-on potential cannot be transmitted to the (k+1)^{th}-stage first register input terminal 11 due to the disconnection between the k^{th}-stage first register output terminal 12 and the (k+1)^{th}-stage first register input terminal 11. As a result, the scan signal SCANk+1 output by the (k+1)^{th}-stage first shift register 10k+1 in the current frame of display does not contain turn-on potential and only outputs cutoff potential. Thus, a row of sub-pixels corresponding to the k^{th}-stage first shift register 10k are in an active frame, and a row of sub-pixels corresponding to the (k+1)^{th} stage first shift register 10k+1 are in an idle frame, and the position between the above two rows of sub-pixels is a partition position for reduced-frequency display of the display panel.

When the first cascade control unit 210 in a certain first cascade control module 201 controls the current-stage first register output terminal 12 and the next-stage first register input terminal 11 to be not connected, and the transfer control signal SW5 controls the signal transfer unit 220 in the first cascade control module 201 to be turned on, the display panel can achieve increased-frequency display at the corresponding position of the first cascade control module 201. Still taking the first cascade control module 201 between the k^{th}-stage first shift register 10k and the (k+1)^{th}-stage first shift register 10k+1 as an example, when the k^{th}-stage first register output terminal is disconnected from the (k+1)^{th}-stage first register input terminal, the k^{th}-stage scan signal SCANk does not affect the operation of the (k+1)^{th}-stage first shift register 10k+1. At this time, since the signal transfer unit 220 is turned on, the signal transfer unit 220 generates the start signal required by the (k+1)^{th}-stage first shift register 10k+1 based on the transfer control signal SW5 and the start control signal SC, causing the scan signal SCANk+1 output by the (k+1)^{th}-stage first shift register 10k+1 to contain the turn-on potential. When the k^{th}-stage scan signal SCANk in the current frame of display does not contain the turn-on potential, the row of sub-pixels corresponding to the k^{th}-stage first shift register 10k are in an idle frame, while the row of sub-pixels corresponding to the (k+1)^{th}-stage first shift register 10k+1 enter an active frame, and the position between the above two rows of sub-pixels is a partition position for increased-frequency display of the display panel.

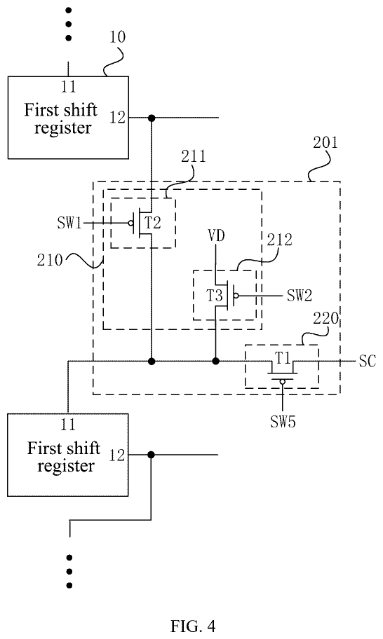

FIG. 4 is a schematic diagram of a structure of another display driving circuit according to an embodiment of the present application. With reference to FIG. 4, In one embodiment,, the first cascade control unit 210 includes a first switch sub-unit 211. A control terminal of the first switch sub-unit 211 is connected to a first switch signal SW1, a first terminal of the first switch sub-unit 211 is electrically connected to the current-stage first register output terminal 12, and a second terminal of the first switch sub-unit 211 is electrically connected to the next-stage first register input terminal 11. The first switch sub-unit 211 is turned on or off based on the first switch signal SW1 to control the current-stage first register output terminal 12 and the next-stage first register input terminal 11 to be connected or not connected.

In one embodiment, the first cascade control unit 210 may further include a second switch sub-unit 212. A control terminal of the second switch sub-unit 212 is connected to a second switch signal SW2, a first terminal of the second switch sub-unit 212 is connected to an auxiliary turn-off signal VD, and a second terminal of the second switch sub-unit 212 is electrically connected to the next-stage first register input terminal 11. The second switch signal SW2 can control the second switch sub-unit 212 to be turned on when both the first switch sub-unit 211 and the signal transfer unit 220 are turned off, to transmit the auxiliary turn-off signal VD to the next-stage first register input terminal 11 to prevent the next-stage first register input terminal 11 from floating, thereby enabling the next-stage first shift register 10 to stably output the cutoff potential of the scan signal. By way of example, the auxiliary turn-off signal VD may be a direct-current voltage signal, and the potential of the auxiliary turn-off signal VD may be the cutoff potential of the scan signal.

The embodiments of the present application can achieve both multi-frequency display with fixed partition positions, and multi-frequency display with adjustable partition positions. Detailed explanations are provided below.

In one embodiment,, a limited number of first cascade control modules are arranged corresponding to a target increased-frequency partition position of the display panel, and a limited number of second cascade control modules are arranged corresponding to a target reduced-frequency partition position of the display panel, thereby enabling multi-frequency display with fixed partition positions.

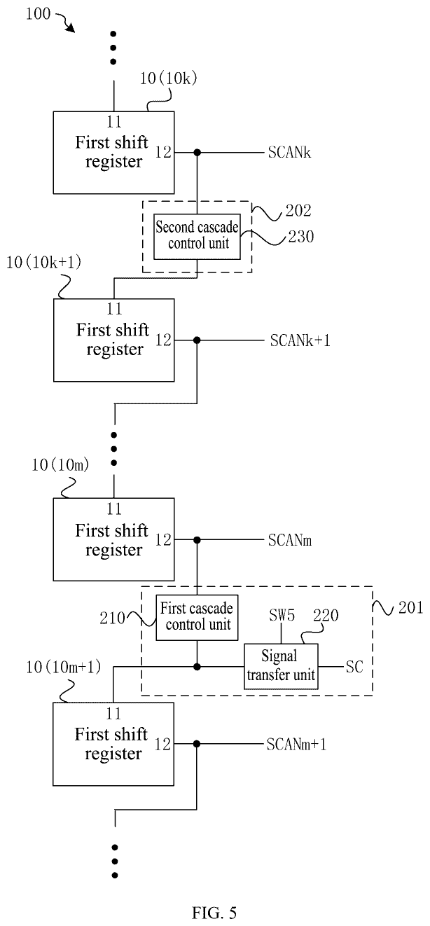

As shown in FIG. 5, the second cascade control module 202 includes a second cascade control unit 230. The second cascade control unit 230 is connected between two stages of first shift registers 10. The second cascade control unit 230 is configured to control the connection state between the current-stage first register output terminal 12 and the next-stage first register input terminal 11.

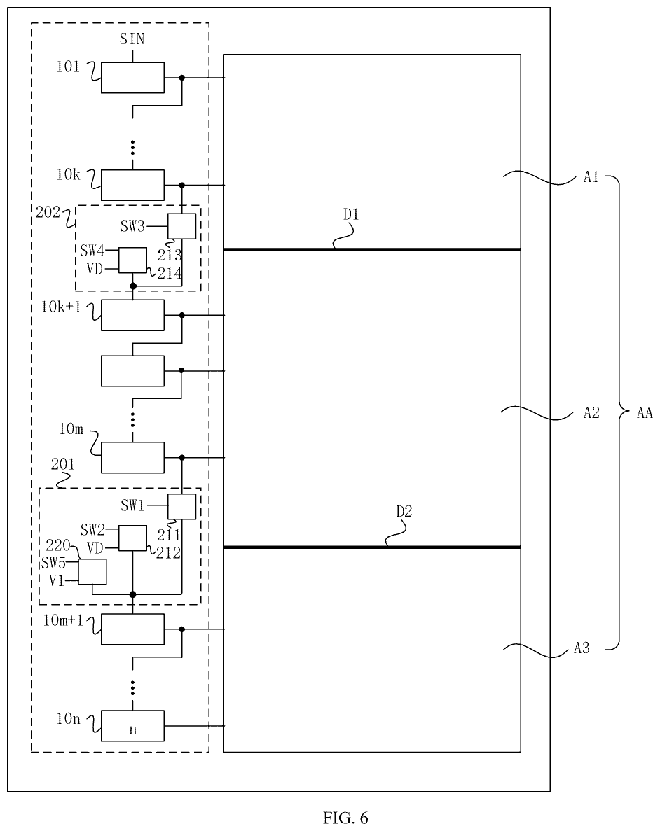

By way of example, the second cascade control unit 230 may have the same structure as the first cascade control unit 210, and can perform the same control process as the first cascade control unit 210. As shown in FIG. 6, the second cascade control unit includes a third switch sub-unit 213, which is connected between two adjacent stages of first shift registers and connected to a third switch signal SW3. The second cascade control unit may further include a fourth switch sub-unit 214, which is electrically connected to a corresponding next-stage first register input terminal and connected to a fourth switch signal SW4 and the auxiliary turn-off signal VD.

By way of example, each second cascade control module 202 may also be provided with a signal transfer unit, that is, the second cascade control module 202 may have the same structure as the first cascade control module 201, enabling both increased-frequency display and reduced-frequency display between any two adjacent sub-active areas.

By way of example, in the first scan driving circuit 100, the transfer control signals SW5 are arranged in one-to-one correspondence with the signal transfer units 220. The start control signal SC includes: a reference signal having fixed potential. The potential of the reference signal determines the potential of the start signal transmitted to the next-stage first register input terminal 11. The transfer control signal SW5 determines the pulse width of the signal transmitted to the next-stage first register input terminal 11 by controlling the on time of the signal transfer unit 220. In this embodiment, such a configuration enables separate control of each signal transfer unit 220, preventing two signal transfer units 220 from transmitting reference signals to the next-stage first register input terminal 11 at the same moment, which could cause erroneous driving of sub-pixels. Additionally, the start control signal SC may include the reference signal, thereby making the first scan driving circuit have a simple structure and making it easy to implement. By way of example, the reference signal may be a direct-current voltage signal, and the potential of the reference signal may be, for example, the turn-on potential of the scan signal. For example, the signal line for transmitting the turn-on potential to the first shift register 10 can be reused as a reference signal line to simplify the structure of the display panel. The transfer control signal SW5, by controlling the on time of the signal transfer unit 220 to be the same as the turn-on pulse width of the scan signal (i.e., the duration for which the scan signal remains at the turn-on potential), can make the start signal transmitted to the next-stage first register input terminal 11 more closely resemble the waveform of the turn-on pulse of the scan signal, thereby ensuring that the next-stage first shift register 10 can resume outputting the turn-on potential. A detailed description of the multi-frequency display scheme with fixed partition positions is provided below taking an example where a first scan driving circuit includes one first cascade control module 201 and one second cascade control module 202 arranged along the sub-pixel column direction.

FIG. 6 is a schematic diagram of a structure of a display panel according to an embodiment of the present application. With combined reference to FIGS. 5 and 6, In one embodiment,, the display panel includes a total of n rows of sub-pixels, and the first scan driving circuit 100 includes a total of n stages of first shift registers, where n is a positive integer greater than 1, for example, 1920. The first register input terminal of the 1^{st}-stage first shift register 101 can be connected to a scan input signal SIN. A first cascade control unit 210 in one first cascade control module 201 is connected between the m^{th}-stage first shift register 10m and the (m+1)^{th}-stage first shift register 10m+1, that is, the first cascade control module 201 is arranged corresponding to a second target partition position D2 of the display panel. A second cascade control unit 230 in one second cascade control module 202 is connected between the k^{th}-stage first shift register 10k and the (k+1)^{th} stage first shift register 10k+1, that is, the second cascade control module 202 is arranged corresponding to a first target partition position D1 of the display panel. Here, k is a positive integer less than m.

The above two target partition positions divide the active area AA of the display panel into a first sub-active area A1, a second sub-active area A2, and a third sub-active area A3, enabling the display panel to support triple-split-screen multi-frequency display. Taking an example in which the display panel achieves reduced-frequency display at the first target partition position D1 and increased-frequency display at the second target partition position D2, it is assumed that the first sub-active area A1 displays at a refresh frequency of f1, the second sub-active area A2 displays at a refresh frequency of f2, and the third sub-active area A3 displays at a refresh frequency of f3, with f1≥f3>f2. Then, the display panel may exhibit the following three display states: a first display state in which each row of sub-pixels in the entire active area AA are in an active frame; a second display state in which each row of sub-pixels in the first sub-active area A1 and the third sub-active area A3 are in an active frame, while each row of sub-pixels in the second sub-active area A2 are in an idle frame; and a third display state in which each row of sub-pixels in the first sub-active area A1 are in an active frame, while each row of sub-pixels in the second sub-active area A2 and the third sub-active area A3 are in an idle frame.

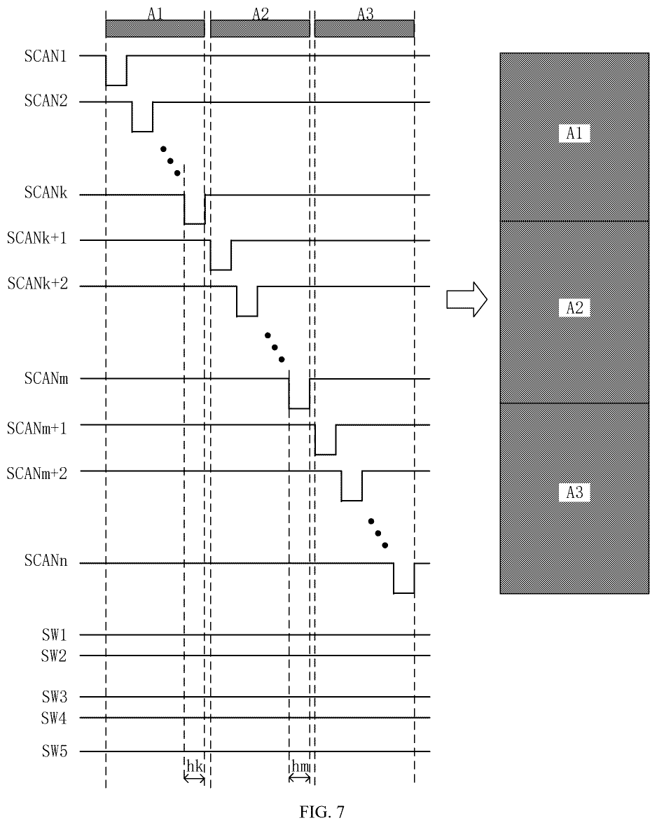

Taking an example in which the turn-on potential of the scan signal is low potential, and the first switch sub-unit 211, the second switch sub-unit 212, the third switch sub-unit 213, the fourth switch sub-unit 214, and the signal transfer unit 220 are all turned on in response to the low potential, the driving processes in the aforementioned three display states are described below with combined reference to FIGS. 7 to 9, respectively. Here, the low potential transmission time of the i^{th}-stage scan signal, that is, the scan time of the i^{th} row of sub-pixels, is denoted by hi.

FIG. 7 is a timing diagram of driving signals for a display frame according to an embodiment of the present application. With reference to FIGS. 6 and 7, in this display frame, each row of sub-pixels in the entire active area AA are in an active frame, requiring the stage-by-stage propagation of the turn-on potential between the 1^{st}-stage scan signal SCAN1 and the n^{th}-stage scan signal SCANn. Then, during the phase of the scan time hk of the k^{th} row of sub-pixels, the first register output terminal of the k^{th}-stage first shift register 10k needs to be in communication with the first register input terminal of the (k+1)^{th}-stage first shift register 10k+1 to ensure that the turn-on potential of the k^{th}-stage scan signal SCANk can be transmitted to the (k+1)^{th}-stage first shift register 10k+1. Additionally, during the phase of the scan time hm of the m^{th} row of sub-pixels, the first register output terminal of the m^{th}-stage first shift register 10m needs to be in communication with the first register input terminal of the (m+1)^{th}-stage first shift register 10m+1 to ensure that the turn-on potential of the m^{th}-stage scan signal SCANm can be transmitted to the (m+1)^{th}-stage first shift register 10m+1.

Thus, during the phase of the scan time hk of the k^{th} row of sub-pixels and the phase of the scan time hm of the m^{th} row of sub-pixels, the first switch signal SW1 remains at low potential, the second switch signal SW2 remains at high potential, the third switch signal SW3 remains at low potential, the fourth switch signal SW4 remains at high potential, and the transfer control signal SW5 remains at high potential. This causes the first switch sub-unit 211 and the third switch sub-unit 213 to be turned on, while the second switch sub-unit 212, the fourth switch sub-unit 214, and the signal transfer unit 220 remain turned off. As a result, the turn-on potential of each stage of scan signal is transmitted to the next-stage first register input terminal, and the auxiliary turn-off signal VD and the reference signal V1 do not affect this signal transmission process. During the phases of the scan time of sub-pixels in rows other than the k^{th} and m^{th} rows, the transfer control signal SW5 is required to remain at high potential to control the signal transfer unit 220 in the first cascade control module 201 to be turned off, avoiding the appearance of low potential in the (m+1)^{th}-stage scan signal SCANm+1 at the time outside the phases of the scan time of the (m+1)^{th} row of sub-pixels. Additionally, during the phases of the scan time of sub-pixels in rows other than the k^{th} and m^{th} rows, both the k^{th}-stage scan signal SCANk and the m^{th}-stage scan signal SCANm remain at the cutoff potential. Therefore, the on states of all switch sub-units do not affect the signal propagation process during the phases of the scan time of other rows of sub-pixels, and the potential of the switch signals can be set arbitrarily. Here, by way of example, a case is illustrated where during the phases of the scan time of other rows of sub-pixels, the first switch signal SW1 and the third switch signal SW3 remain at low potential, while the second switch signal SW2 and the fourth switch signal SW4 remain at high potential. As such, in this display frame, the switch signals do not undergo potential jumps, which can simplify control logic.

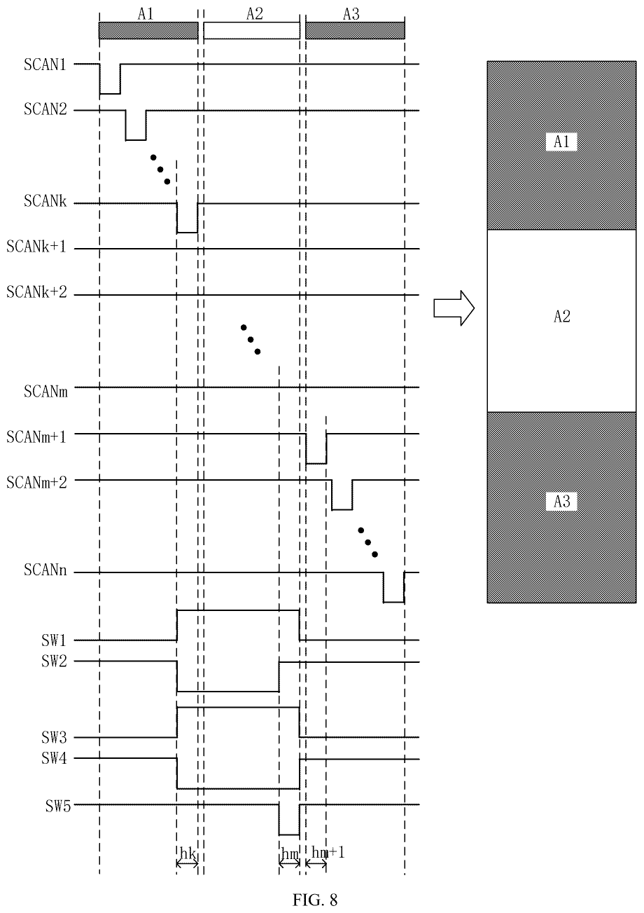

FIG. 8 is a timing diagram of driving signals for another display frame according to an embodiment of the present application. With reference to FIGS. 6 and 8, in this display frame, each row of sub-pixels in the first sub-active area A1 and the third sub-active area A3 are in an active frame, while each row of sub-pixels in the second sub-active area A2 are in an idle frame.

Before the phase of the scan time hk of the k^{th} row of sub-pixels, since the k^{th}-stage first shift register 10k has not yet output the turn-on potential, the on states of the switch sub-units do not affect the signal propagation process during this phase, and the potential of the switch signals can be set arbitrarily. In one embodiment, at least one of the first switch sub-unit 211 and the second switch sub-unit 212 can be set to turn on, and at least one of the third switch sub-unit 213 and the fourth switch sub-unit 214 can be set to turn on, enabling reliable input of the cutoff potential into the (k+1)^{th}-stage and (m+1)^{th}-stage first register input terminals. Here, by way of example, a case is illustrated where the first switch signal SW1 and the third switch signal SW3 remain at low potential, while the second switch signal SW2 and the fourth switch signal SW4 remain at high potential. Before the phase of the scan time hk, the transfer control signal SW5 is required to remain at high potential to control the signal transfer unit 220 in the first cascade control module 201 to be turned off, avoiding the premature appearance of low potential in the (m+1)^{th}-stage scan signal SCANm+1.

During the phase of the scan time hk of the k^{th} row of sub-pixels, since the (k+1)^{th} row of sub-pixels needs to enter the idle frame, the second cascade control module 202 is required to block backward transmission of the low potential of the k^{th}-stage scan signal SCANk. Therefore, during this phase, the third switch signal SW3 jumps to high potential, and the fourth switch signal SW4 jumps to low potential, disconnecting the k^{th} -stage first register output terminal from the (k+1)^{th}-stage first register input terminal, so that the auxiliary turn-off signal VD is transmitted to the (k+1)^{th}-stage first register input terminal via the fourth switch sub-unit 214 to ensure that the (k+1)^{th}-stage first shift register 10k+1 does not output low potential. During the phase of the scan time hk, to avoid premature appearance of low potential in the (m+1)^{th}-stage scan signal SCANm+1, the transfer control signal SW5 remains at high potential. During this phase, since the turn-on potential of the scan signal has not yet been transmitted to the m^{th}-stage first shift register, the m^{th}-stage scan signal SCANm remains at the cutoff potential. Therefore, the on states of the first switch sub-unit 211 and the second switch sub-unit 212 do not affect the signal propagation process between the m^{th}-stage and the (m+1)^{th}-stage first shift registers. In one embodiment, at least one of the first switch sub-unit 211 and the second switch sub-unit 212 can be set to turn on, enabling reliable input of the cutoff potential into the (m+1)^{th}-stage first register input terminal. Here, by way of example, a case is illustrated where during the phase of the scan time hk of the k^{th} row of sub-pixels, the first switch signal SW1 jumps to high potential, while the second switch signal SW2 jumps to low potential.

From the scan time of the (k+1)^{th} row of sub-pixels to before the phase of the scan time hm of the m^{th} row of sub-pixels, since the k^{th}-stage first shift register 10k continuously outputs the cutoff potential of the scan signal and the phase of the scan time hm of the m^{th} row of sub-pixels has not yet been reached, the on states of the switch sub-units do not affect the signal propagation process during this phase, and the potential of the switch signals can be set arbitrarily. Here, by way of example, a case is illustrated where the first switch signal SW1 and the third switch signal SW3 remain at high potential, while the second switch signal SW2 and the fourth switch signal SW4 remain at low potential. From the scan time of the (k+1)^{th} row of sub-pixels to before the phase of the scan time hm of the m^{th} row of sub-pixels, to avoid premature appearance of low potential in the (m+1)^{th}-stage scan signal SCANm+1, the transfer control signal SW5 remains at high potential.

During the phase of the scan time hm of the m^{th} row of sub-pixels, since the (m+1)^{th} row of sub-pixels is required to enter the active frame, the first cascade control module 201 needs to provide a start signal to the (m+1)^{th}-stage first register input terminal. Therefore, during this phase, the first switch signal SW1 remains at high potential, while the second switch signal SW2 jumps to high potential. Both the first switch sub-unit 211 and the second switch sub-unit 212 in the first cascade control module 201 are turned off, ensuring that neither the m^{th}-stage scan signal SCANm nor the auxiliary turn-off signal VD affects the operational state of the (m+1)^{th}-stage first shift register 10m+1. Meanwhile, the transfer control signal SW5 jumps to low potential during this phase, controlling the signal transfer unit 220 to be turned on, thereby transmitting the reference signal V1 to the (m+1)^{th}-stage first register input terminal. The potential of the reference signal V1 is the turn-on potential of the scan signal, i.e., low potential, so that starting from the (m+1)^{th}-stage first shift register 10m+1, the stage-by-stage transmission of the turn-on potential of the scan signal is re-implemented. Here, the duration of the transfer control signal SW5 at the low potential is equal to or slightly greater than the pulse width of the low potential of the scan signal, so that the start signal transmitted to the (m+1)^{th}-stage first register input terminal is close to the original turn-on pulse of the m^{th}-stage scan signal. During this phase, since the k^{th}-stage scan signal SCANk remains at the cutoff potential, the on states of the third switch sub-unit 213 and the fourth switch sub-unit 214 do not affect the signal propagation process between the k^{th}-stage and the (k+1)^{th}-stage first shift registers. In one embodiment, at least one of the third switch sub-unit 213 and the fourth switch sub-unit 214 can be set to turn on, enabling reliable input of the cutoff potential into the (k+1)^{th}-stage first register input terminal. Here, by way of example, a case is illustrated where during the phase of the scan time hm of the m^{th} row of sub-pixels, the third switch signal SW3 remains at high potential, while the fourth switch signal SW4 remains at low potential, minimizing the number of signal jumps.

From the phase of the scan time of the (m+1)^{th} row of sub-pixels to the end of the current frame, since the k^{th}-stage first shift register 10k and the m^{th}-stage first shift register 10m continuously output the cutoff potential of the scan signal, the on states of the switch sub-units do not affect the signal propagation process during this phase, and the potential of the switch signals can be set arbitrarily. In one embodiment, at least one of the first switch sub-unit 211 and the second switch sub-unit 212 can be set to turn on, and at least one of the third switch sub-unit 213 and the fourth switch sub-unit 214 can be set to turn on, enabling reliable input of the cutoff potential into the (k+1)^{th}-stage and (m+1)^{th}-stage first register input terminals. Here, by way of example, a case is illustrated where the first switch signal SW1 and the third switch signal SW3 remain at low potential, while the second switch signal SW2 and the fourth switch signal SW4 remain at high potential. From the scan time of the (m+1)^{th} row of sub-pixels to the end of the current frame, to avoid reappearance of low potential in the (m+1)^{th}-stage scan signal SCANm+1, the transfer control signal SW5 remains at high potential.

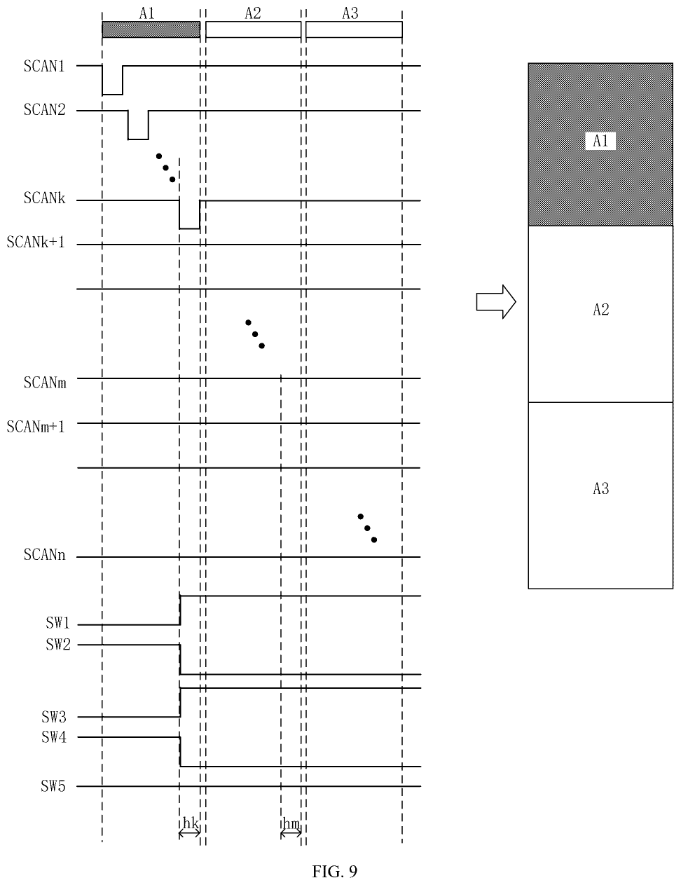

FIG. 9 is a timing diagram of driving signals for a further display frame according to an embodiment of the present application. With reference to FIGS. 6 and 9, in this display frame, each row of sub-pixels in the first sub-active area A1 are in an active frame, while each row of sub-pixels in the second sub-active area A2 and the third sub-active area A3 are in an idle frame. In the phases before the phase of the scan time hm of the m^{th} row of sub-pixels, the states of all control signals are identical to those shown in FIG. 8 for the phases before the phase of the scan time hm of the m^{th} row of sub-pixels, which will not be repeated.

During the phase of the scan time hm of the m^{th} row of sub-pixels, since both the (m+1)^{th} row of sub-pixels and the m^{th} row of sub-pixels need to remain in the idle frame, the first cascade control module 201 does not need to provide a start signal to the (m+1)^{th}-stage first register input terminal. Therefore, during this phase, the transfer control signal SW5 remains at high potential, controlling the signal transfer unit 220 to be turned off to prevent the low potential of the reference signal V1 from being transmitted to the (m+1)^{th}-stage first register input terminal. Since the m^{th}-stage scan signal SCANm contains no turn-on potential, during this phase, the on states of the switch sub-units do not affect the signal propagation process, and the potential of the switch signals can be set arbitrarily. In one embodiment, at least one of the first switch sub-unit 211 and the second switch sub-unit 212 can be set to turn on, and at least one of the third switch sub-unit 213 and the fourth switch sub-unit 214 can be set to turn on, enabling reliable input of the cutoff potential into the (k+1)^{th}-stage and (m+1)^{th}-stage first register input terminals. Here, by way of example, a case is illustrated where the first switch signal SW1 and the third switch signal SW3 remain at high potential, while the second switch signal SW2 and the fourth switch signal SW4 remain at low potential. On this basis, the transfer control signal SW5 controlling the signal transfer unit 220 to be turned off can also avoid short circuits caused by simultaneous transmission of the low potential of the reference signal V1 and the high potential of the auxiliary turn-off signal VD to the (m+1)^{th}-stage first register input terminal, which result in device damage.

From the phase of the scan time of the (m+1)^{th} row of sub-pixels to the end of the current frame, since the k^{th}-stage first shift register 10k and the m^{th}-stage first shift register 10m continuously output the high potential, the on states of the switch sub-units do not affect the signal propagation process during this phase, and the potential of the switch signals can be set arbitrarily. In one embodiment, at least one of the first switch sub-unit 211 and the second switch sub-unit 212 can be set to turn on, and at least one of the third switch sub-unit 213 and the fourth switch sub-unit 214 can be set to turn on, enabling reliable input of the cutoff potential into the (k+1)^{th}-stage and (m+1)^{th}-stage first register input terminals. Here, by way of example, a case is illustrated where the first switch signal SW1 and the third switch signal SW3 remain at high potential, while the second switch signal SW2 and the fourth switch signal remain at low potential. During this phase, to avoid appearance of low potential in the (m+1)^{th}-stage scan signal SCANm+1, the transfer control signal SW5 is required to remain at high potential.

On the basis of the aforementioned implementations, optionally, the first switch signal SW1 can be reused as the third switch signal SW3, and the second switch signal SW2 can be reused as the fourth switch signal SW4.

In practical applications, by adjusting the order and numbers of the aforementioned three types of display frames, various combinations of partitions and display frequencies can be achieved.

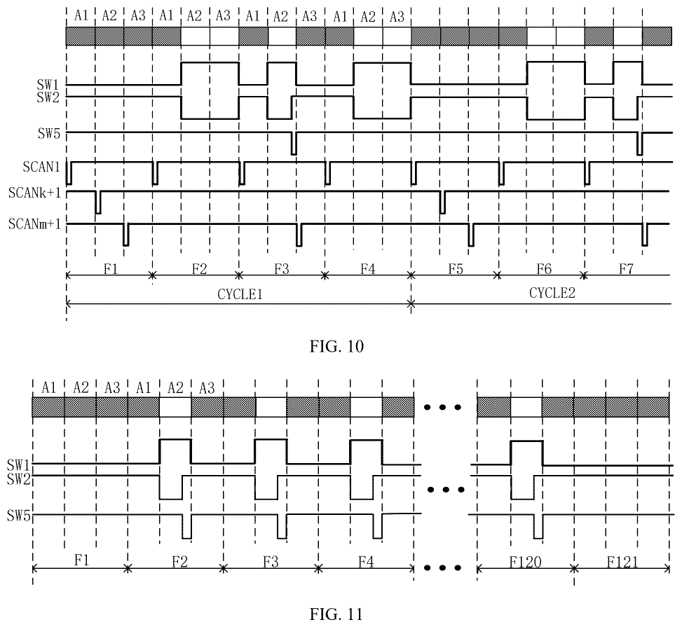

FIG. 10 is a schematic diagram of a driving timing sequence of a display panel according to an embodiment of the present application. As shown in FIG. 10, In one embodiment, f2=f1/4, and f3=f1/2, then for each row of sub-pixels in the first sub-active area A1, the display frames can be active frames. FIG. 10 exemplarily shows the waveform of the 1^{st}-stage scan signal SCAN1. It can be seen that in each frame of display, the 1^{st}-stage scan signal SCAN1 includes a turn-on pulse. For each row of sub-pixels in the second sub-active area A2, two adjacent active frames may be arranged to be spaced apart by three idle frames. FIG. 10 exemplarily shows the waveform of the (k+1)^{th}-stage scan signal SCANk+1. It can be seen that the (k+1)^{th}-stage scan signal SCANk+1 includes a turn-on pulse in display frames F1 and F5, that is, it includes a turn-on pulse only in the (4i+1)^{th} display frame, while maintaining cutoff potential in the other display frames. For each row of sub-pixels in the third sub-active area A3, odd-numbered frames can be set as active frames, and even-numbered frames can be set as idle frames. FIG. 10 exemplarily shows the waveform of the (m+1)^{th}-stage scan signal SCANm+1. It can be seen that the (m+1)^{th}-stage scan signal SCANm+1 includes a turn-on pulse only in odd-numbered frames. Taking the 4 display frames F1 to F4 as one cycle (CYCLE1), by repeating the driving process within this cycle, stable partitioned multi-frequency display can be implemented, with the first sub-active area A1 displaying at a refresh frequency of f1, the second sub-active area A2 displaying at a refresh frequency of f1/4, and the third sub-active area A3 displaying at a refresh frequency of f1/2. Based on the display states of the sub-active areas in the display panel, the waveforms of the first switch signal SW1, the second switch signal SW2, the third switch signal SW3, the fourth switch signal SW4, and the transfer control signal SW5 are set. FIG. 10 exemplarily illustrates the waveforms of the first switch signal SW1, the second switch signal SW2, and the transfer control signal SW5 in the case where the first switch signal SW1 is reused as the third switch signal SW3, and the second switch signal SW2 is reused as the fourth switch signal SW4. In other embodiments, the waveforms of the first switch signal SW1, the second switch signal SW2, the third switch signal SW3, the fourth switch signal SW4, and the transfer control signal SW5 may be other waveforms as described in the implementations of FIGS. 7 to 9, as long as different display states corresponding to different refresh frequencies in each sub-active area of the display panel can be achieved, which will not be repeated here.

FIG. 11 is a schematic diagram of a driving timing sequence of another display panel according to an embodiment of the present application. With reference to FIG. 11, by way of example, f1=f3 and f2=f1/120. Then, for each row of sub-pixels in the first sub-active area A1 and the third sub-active area A3, each display frame can be an active frame; and for each row of sub-pixels in the second sub-active area A2, an interval of 119 idle frames can be set between two adjacent active frames. Taking the 120 display frames F1 to F120 as one cycle, by repeating the driving process within this cycle, stable partitioned multi-frequency display can be implemented, with the first sub-active area A1 displaying at a refresh frequency of f1, the second sub-active area A2 displaying at a refresh frequency of f1/120, and the third sub-active area A3 displaying at a refresh frequency of f1. FIG. 11 exemplarily illustrates the waveforms of the first switch signal SW1, the second switch signal SW2, and the transfer control signal SW5 in the case where the first switch signal SW1 is reused as the third switch signal SW3, and the second switch signal SW2 is reused as the fourth switch signal SW4. With reference to FIGS. 6 and 11, during the phase of the scan time hk of the k^{th} row of sub-pixels in each of the display frames F2 to F120, the first switch signal SW1 is at high potential, while the second switch signal SW2 is at low potential. Since the first switch signal SW1 is reused as the third switch signal SW3, and the second switch signal SW2 is reused as the fourth switch signal SW4, the connection between the k^{th}-stage first register output terminal and the (k+1)^{th}-stage first register input terminal is disconnected. The auxiliary turn-off signal VD is transmitted to the (k+1)^{th}-stage first register input terminal via the fourth switch sub-unit 214 in the second cascade control module 202, ensuring that the (k+1)^{th}-stage first shift register 10k+1 does not output low potential. During the phase of the scan time hm of the m^{th} row of sub-pixels in each of the display frames F2 to F120, the transfer control signal SW5 is at low potential, and the signal transfer unit 220 is controlled to be turned on, transmitting the reference signal V1 to the (m+1)^{th}-stage first register input terminal. This enables the stage-by-stage transmission of the turn-on potential of the scan signal to be re-implemented starting from the (m+1)^{th}-stage first shift register 10m+1, thereby allowing the first sub-active area A1 to display at a refresh frequency of f1, the second sub-active area A2 to display at a refresh frequency of f1/120, and the third sub-active area A3 to display at a refresh frequency of f1.

When it is necessary to adjust the refresh frequency of each active area, the driving cycle process can be adjusted. For example, the display may adopt the cycle mode shown in FIG. 10 for a certain period of time, and adopt the cycle mode shown in FIG. 11 for another period of time. In other time periods, it is also possible to control all rows of sub-pixels in the entire active area AA in each display frame to be in an active frame, and so on. This can achieve a display scheme in which the partition positions are fixed, but the refresh frequency of each sub-active area is dynamically adjusted. The above cycle modes are only shown as examples and are not intended to limit the present application. In actual display, the refresh frequencies of the sub-active areas can be configured according to actual requirements.

The above implementations exemplarily illustrate that the refresh frequency f1 of the first sub-active area A1 is greater than or equal to the refresh frequency f3 of the third sub-active area A3, which, however, is not intended to limit the present application. In other implementations, it is also possible to set f1<f3. In such cases, there may also be display frames that are in a display state in which each row of sub-pixels in the first sub-active area A1 and the second sub-active area A2 are in an idle frame, and each row of sub-pixels in the third sub-active area A3 are in an active frame. At this time, it is only necessary to set the scan input signal SIN not to provide the turn-on potential of the scan signal to the first-stage first shift register 101 at the start of this frame, and to provide the start signal to the (m+1)^{th}-stage first shift register 10m+1 through the first cascade control module 201 during the phase of the scan time hm of the m^{th} row of sub-pixels.

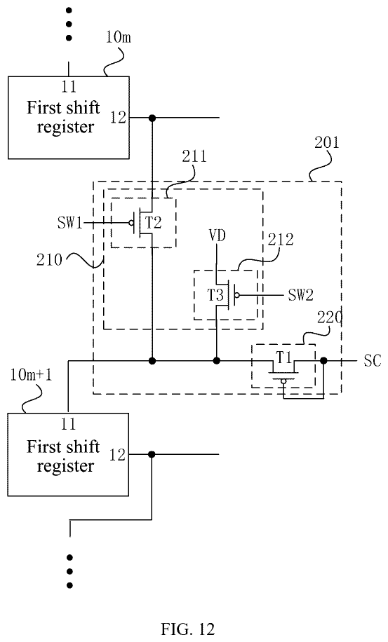

The constitutions of each cascade control unit 210 and each signal transfer unit 220 in the above implementations are not intended to limit the present application. In other implementations, as shown in FIG. 12, it is also possible to set both the transfer control signal and the start control signal SC as pulse signals, and the signal transfer unit 220 is configured to transmit the pulse signal to the next-stage first register input terminal in response to the transfer control signal. Correspondingly, it is possible to set the control terminal of the signal transfer unit 220 to be connected to the input terminal, and the transfer control signal can be reused as the start control signal SC. When the start control signal SC is at the cutoff potential, the signal transfer unit 220 is turned off; and when the start control signal SC is at the turn-on potential, the signal transfer unit 220 is turned on and transmits this turn-on potential to the next-stage first register input terminal. In a certain display frame, when the display panel needs to achieve increased-frequency display between the m^{th} row of sub-pixels and the (m+1)^{th} row of sub-pixels, during the phase of the scan time of the m^{th} row of sub-pixels, the first switch signal SW1 and the second switch signal SW2 can both be controlled to be at the cutoff potential, and the start control signal SC can be controlled to be at the turn-on potential. When the first scan driving circuit includes a plurality of signal transfer units 220, the start control signals can be set in one-to-one correspondence with the signal transfer units.

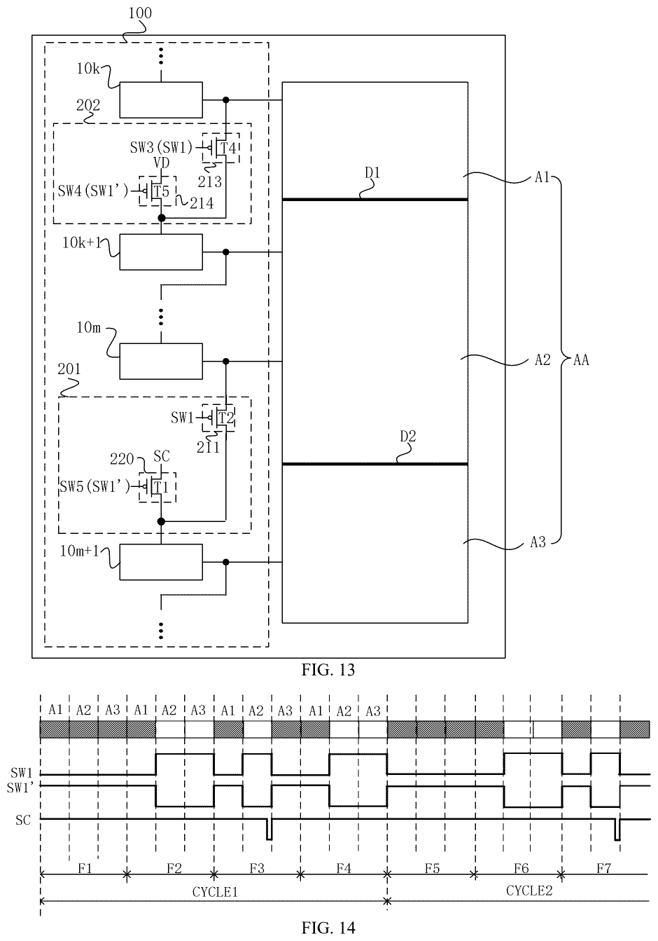

FIG. 13 is a schematic diagram of a structure of another display panel according to an embodiment of the present application, and FIG. 14 is a schematic diagram of a driving timing sequence of a further display panel according to an embodiment of the present application. With reference to FIGS. 13 and 14, in another implementation, optionally, a first switch sub-unit 211 and a signal transfer unit 220 are arranged in the first cascade control module 201, and a third switch sub-unit 213 and a fourth switch sub-unit 214 are arranged in the second cascade control module 202. In one embodiment, the first switch signal SW1 can be reused as the third switch signal SW3; and the transfer control signal SW5 can be reused as the fourth switch signal SW4 (using the switch control signal SW1′ as the transfer control signal SW5 and the fourth switch signal SW4), where the switch control signal SW1′ and the first switch signal SW1 are opposite in phase, and the start control signal SC is a pulse signal whose potential can be changed according to requirements. With this configuration, the structure of the first cascade control module 201 can be effectively simplified. When there are a plurality of signal transfer units 220, they can be connected to the same switch control signal SW1′ and connected in one-to-one correspondence with different start control signals SC.

In the embodiment of the present application, when the switch control signal SW1′ is at the turn-on potential, the signal transfer unit 220 is turned on, transmitting the start control signal SC to the (m+1)^{th}-stage first shift register 10m+1. The pulse width of the start control signal SC determines the pulse width of the signal transmitted to the next-stage first register input terminal. As shown in FIG. 14, during the phase of the scan time of the m^{th} row of sub-pixels, when the (m+1)^{th}-stage first shift register 10m+1 does not need to be refreshed (for example, in the display frame F2), the start control signal SC can be set to be at the cutoff potential (for example, high potential). During the phase of the scan time of the m^{th} row of sub-pixels, when the (m+1)^{th}-stage first shift register 10m+1 needs to be refreshed (for example, in the display frame F3), the start control signal SC can be set to be at the turn-on potential (for example, low potential).

It should be noted that in this embodiment, since the fourth switch sub-unit 214 is arranged in the second cascade control module 202, while no second switch sub-unit is arranged in the first cascade control module 201, the switch control signal SW1′ can adopt the inverted signal of the first switch signal SW1. Moreover, the signal transfer unit 220 and the fourth switch sub-unit 214 can be connected to the same switch control signal SW1′, which will not affect the normal operation of the signal transfer unit 220. By way of example, during the phase when the fourth switch sub-unit 214 is turned on in response to the switch control signal SW1′, the fourth switch sub-unit 214 transmits the auxiliary turn-off signal VD to the (k+1)^{th}-stage first shift register 10k+1. During this phase, the signal transfer unit 220 is turned on in response to the switch control signal SW1′ and transmits the start control signal SC to the (m+1)^{th}-stage first shift register 10m+1. The start control signal SC remains at the cutoff potential in the case where the (m+1)^{th}-stage first shift register does not need to output the turn-on potential of the scan signal, and the start control signal SC is changed to be at the turn-on potential in the case where the (m+1)^{th}-stage first shift register needs to output the turn-on potential of the scan signal. The switch state of the fourth switch sub-unit 214 can be opposite to that of the first switch sub-unit 211 (and the third switch sub-unit 213).

With continued reference to FIG. 4, on the basis of the aforementioned

implementations, optionally, the signal transfer unit includes: a first transistor T1, where a gate of the first transistor T1 is connected to the transfer control signal SW5, a first electrode of the first transistor T1 is connected to the start control signal SC, and a second electrode of the first transistor T1 is electrically connected to a corresponding next-stage first register input terminal 11.

The first switch sub-unit 211 includes a second transistor T2, where a gate of the second transistor T2 is connected to a first switch signal SW1, a first electrode of the second transistor T2 is electrically connected to a corresponding current-stage first register output terminal 12, and a second electrode of the second transistor T2 is electrically connected to a corresponding next-stage first register input terminal 11.

The second switch sub-unit 212 includes a third transistor T3, where a gate of the third transistor T3 is connected to a second switch signal SW2, a first electrode of the third transistor T3 is connected to an auxiliary turn-off signal VD, and a second electrode of the third transistor is electrically connected to a corresponding next-stage first register input terminal 11.

With continued reference to FIG. 13, on the basis of the aforementioned implementations, optionally, the third switch sub-unit 213 includes a fourth transistor T4, where a gate of the fourth transistor T4 is connected to a third switch signal SW3, a first electrode of the fourth transistor T4 is electrically connected to a corresponding current-stage first register output terminal, and a second electrode of the fourth transistor T4 is electrically connected to a corresponding next-stage first register input terminal.

The fourth switch sub-unit 214 includes a fifth transistor T5, where a gate of the fifth transistor T5 is connected to a fourth switch signal SW4, a first electrode of the fifth transistor T5 is connected to an auxiliary turn-off signal VD, and a second electrode of the fifth transistor T5 is electrically connected to a corresponding next-stage first register input terminal.

The aforementioned embodiments exemplarily provide a scheme for multi-frequency display at fixed position partitions of the display panel, which, however, is not intended to limit the present application. In other implementations, multi-frequency display with arbitrarily adjustable partition positions of the display panel can be achieved, which will be described in detail below.

In another implementation, optionally, the at least one first cascade control module includes a plurality of first cascade control modules. The first cascade control module is arranged between corresponding two first shift registers in at least part of the first shift registers to achieve adjustment of partition positions. By way of example, a first cascade control module is arranged between every two adjacent first shift registers. During the actual driving process, the operational state of any first cascade control module can be controlled at any time according to requirements, thereby achieving multi-frequency display with dynamically adjustable partition positions of the display panel.

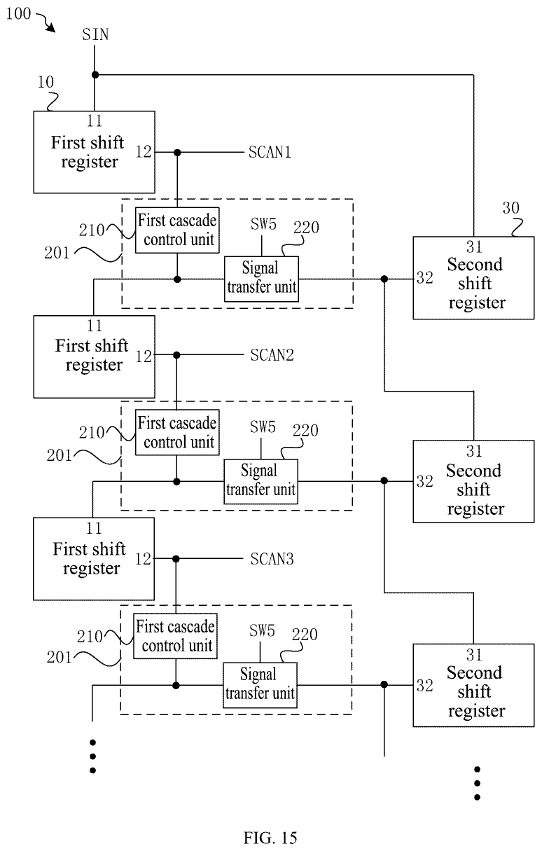

FIG. 15 is a schematic diagram of a structure of a further display driving circuit according to an embodiment of the present application. With reference to FIG. 15, a first cascade control module 201 is arranged between every two adjacent first shift registers 10, and a signal transfer unit 220 is arranged in all first cascade control modules 201. In addition, the first scan driving circuit 100 further includes: a plurality of second shift registers 30 arranged in cascade, where the second shift registers 30 are arranged in one-to-one correspondence with the first shift registers 10. The second shift register 30 includes: a second register input terminal 31 and a second register output terminal 32. A first-stage first register input terminal 11 and a first-stage second register input terminal 31 are both connected to a scan input signal SIN; and an input terminal of the signal transfer unit 220 is electrically connected to a corresponding current-stage second register output terminal 32, and the second register output terminal 32 outputs a corresponding start control signal to the input terminal of the corresponding signal transfer unit 220.

When the scan input signal SIN provides a turn-on pulse, the stages of second shift registers 30 can achieve stage-by-stage output of the turn-on pulse. The arrangement of the stages of second shift registers 30 is equivalent to providing a set of high-frequency turn-on pulse signal sources in the first scan driving circuit 100. The stages of second shift registers 30 always perform shifting output of the turn-on pulse in each display frame. When the signal transfer unit 220 is turned on, the turn-on pulse output by the current-stage second shift register 30 is directly provided as a start signal to the next-stage first shift register 10. Since parameters such as amplitude and pulse width of the turn-on pulse output by the second shift registers 30 are the same as those of the turn-on pulse output by the first shift registers 10, using the output signal of the second shift registers 30 as the start control signal can effectively ensure that the next-stage first shift register 10 can normally output the turn-on pulse of the scan signal to achieve increased-frequency display. In practical applications, the time during which the transfer control signal SW5 controls the signal transfer unit 220 to be turned on can be set to be greater than or equal to the pulse width of the output signal of the current-stage second shift register 30, so that the turn-on pulse can be normally provided to the next-stage first shift register 10.

By way of example, since the second shift registers 30 are configured to provide start signals to the next-stage first shift registers 10, the number of stages of the second shift registers 30 can be 1 less than the number of stages of the first shift registers 10, to minimize the number of unnecessary functional modules in the first scan driving circuit.

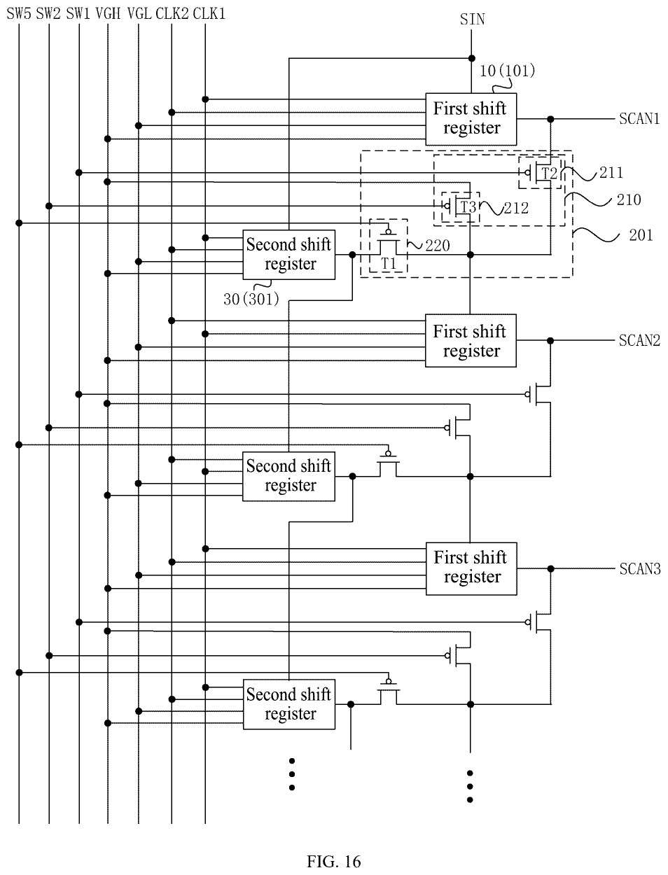

FIG. 16 is a schematic diagram of a structure of a further display driving circuit according to an embodiment of the present application. With reference to FIG. 16, on the basis of the aforementioned implementations, optionally, all signal transfer units 220 can be connected to the same transfer control signal SW5 to simplify the structure of the display driving circuit, making the display driving circuit easier to implement and apply. Since the second shift registers 30 themselves can provide turn-on pulse signals, the signal transfer units 220 can be used solely as switch units. Moreover, only one second shift register 30 outputs the turn-on potential at the same moment, while the other second shift registers 30 output the cutoff potential. Even if all the signal transfer units 220 are turned on, only the stage of second shift register 30 that outputs the turn-on potential will function, and this turn-on potential is transmitted to the next-stage first shift register 10, while the other signal transfer units 220 can only transmit the cutoff potential. Therefore, simultaneous turn-on of all the signal transfer units 220 will neither cause the issue of a plurality of first shift registers 10 receiving the start signal at the same moment, nor will it cause a plurality of first shift registers 10 to output the turn-on potential at the same moment, thus not affecting the normal driving of the display panel.

Similarly, since at the same moment, at most only one first shift register 10 outputs the turn-on potential, while the other first shift registers 10 output the cutoff potential, simultaneous turn-on of all first switch sub-units 211 will not affect the normal driving of the display panel. By contrast, simultaneous turn-off of all the first switch sub-units 211 is equivalent to only affecting the stage of first shift register 10 that is outputting the turn-on potential, preventing the turn-on potential from being transmitted to the next-stage first shift register 10, whereas the other stages of first shift registers 10 continue to output the cutoff potential. Therefore, simultaneous turn-on/off of all the first switch sub-units 211 does not affect the normal driving of the display panel, and all the first switch sub-units 211 can be connected to the same first switch signal SW1. Correspondingly, simultaneous turn-on/off of all second switch sub-units 212 will not affect the normal driving of the display panel, and all the second switch sub-units 212 can be connected to the same second switch signal SW2.

In this embodiment, on the basis of the first shift registers 10, cascaded second shift registers 30 are added. The second shift registers 30 are configured to provide high-frequency turn-on pulse signals, enabling timely provision of start signals to the next-stage first shift registers during the transition to increased-frequency display. In terms of overall control, the potential jump times of the three control signals, namely, the first switch signal SW1, the second switch signal SW2, and the transfer control signal SW5, correspond to the partition graphic refresh frequency information.

For a region in an active frame, during the scan time of each row of sub-pixels in this region, the first switch signal SW1 controls the first switch sub-unit 211 to turn on, the second switch signal SW2 controls the second switch sub-unit 212 to turn off, and the transfer control signal SW5 controls the signal transfer unit 220 to turn off.

At the partition position transitioning from an active frame to an idle frame, during the scan time of the last row of sub-pixels in the active frame, the first switch signal SW1 controls the first switch sub-unit 211 to turn off, the second switch signal SW2 controls the second switch sub-unit 212 to turn on, and the transfer control signal SW5 controls the signal transfer unit 220 to turn off.

For a region in an idle frame, during the scan time of each row of sub-pixels in this region, the first switch signal SW1 controls the first switch sub-unit 211 to turn off, the second switch signal SW2 controls the second switch sub-unit 212 to turn on, and the transfer control signal SW5 controls the signal transfer unit 220 to turn off.

At the partition position transitioning from an idle frame to an active frame, during the scan time of the last row of sub-pixels in the idle frame, the first switch signal SW1 controls the first switch sub-unit 211 to turn off, the second switch signal SW2 controls the second switch sub-unit 212 to turn off, and the transfer control signal SW5 controls the signal transfer unit 220 to turn on.

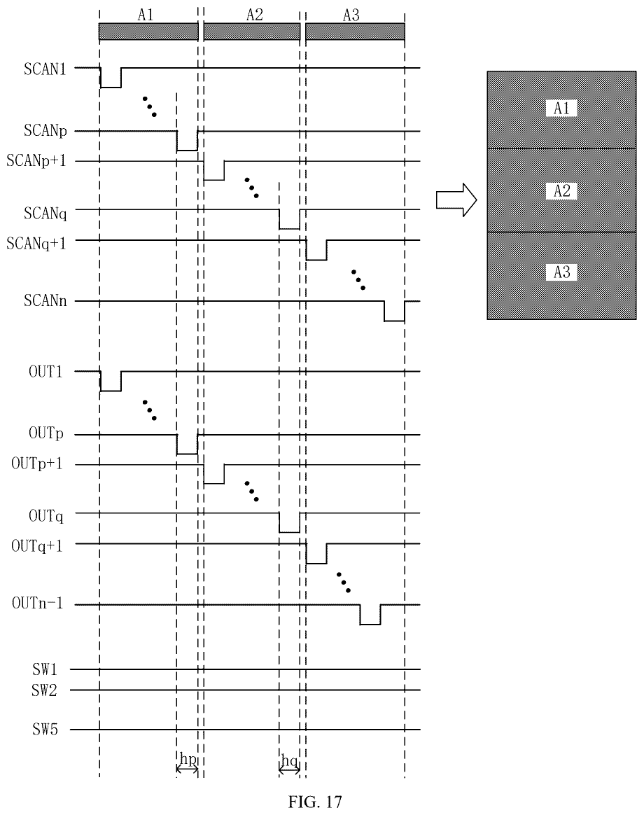

Below, the case where the active area is divided into three sub-active areas is still taken as an example. By way of example, the display panel is provided with n stages of first shift registers 10 and n−1 stages of second shift registers 30. To achieve a display state in which the 1^{st} to p^{th} rows of sub-pixels are refreshed at a high frequency, the (p+1)^{th} to q^{th} rows of sub-pixels are refreshed at a low frequency, and the (q+1)^{th} to n^{th} rows of sub-pixels are refreshed at a high frequency, the display panel may have three display states as shown in FIGS. 17 to 19. Still taking an example in which the turn-on potential of the scan signal is low potential, and the first switch sub-unit 211, the second switch sub-unit 212, and the signal transfer unit 220 are all turned on in response to the low potential, the three display states are explained below.

With reference to FIG. 17, in this display frame, all rows of sub-pixels in the entire active area AA are in the display frame of the active frame. Low-potential pulses are present in the output signals OUT1 to OUTn−1 of all stages of second shift registers. The first switch signal SW1 remains at low potential, the second switch signal SW2 remains at high potential, and the transfer control signal SW5 remains at high potential. Therefore, the first switch sub-unit 211 remains turned on throughout this display frame, while the second switch sub-unit 212 and the signal transfer unit 220 remain turned off throughout this display frame. All stages of first shift registers 10 maintain a cascaded state throughout this display frame, achieving the stage-by-stage transmission of the turn-on potential of the scan signal.

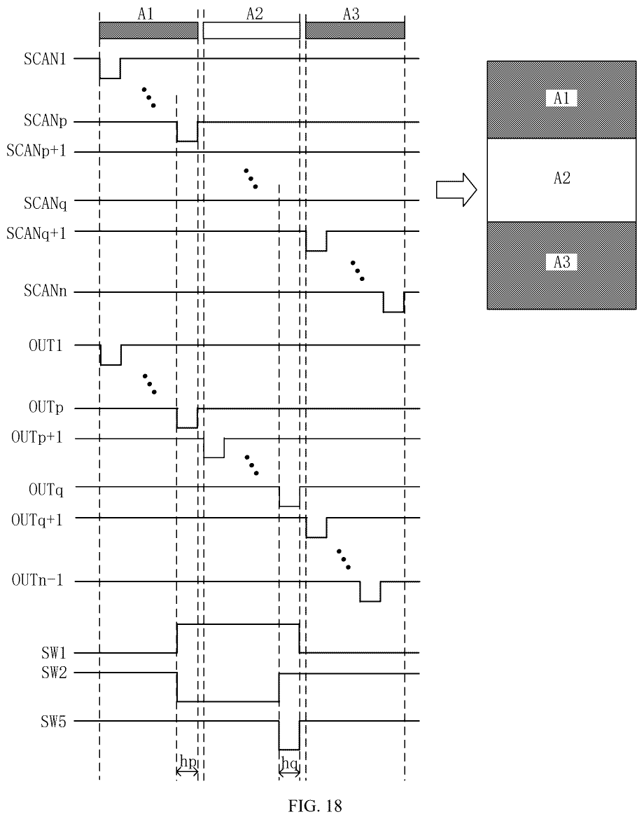

With reference to FIG. 18, in this display frame, each row of sub-pixels in the first sub-active area A1 and the third sub-active area A3 are in the active frame, while each row of sub-pixels in the second sub-active area A2 are in the idle frame. Low-potential pulses are present in the output signals OUT1 to OUTn−1 of all stages of second shift registers.

Before the phase of the scan time hp of the p^{th} row of sub-pixels, the first switch signal SW1 remains at low potential, the second switch signal SW2 remains at high potential, while the transfer control signal SW5 remains at high potential, causing all first switch sub-units 211 to remain turned on, and all second switch sub-units 212 and all signal transfer units 220 to remain turned off. The shift transmission of the turn-on potential of the scan signal can be achieved between the 1^{st}-stage and the p^{th}-stage first shift registers.

During the phase of the scan time hp of the p^{th} row of sub-pixels, the first switch signal SW1 jumps to high potential, the second switch signal SW2 jumps to low potential, and the transfer control signal SW5 remains at high potential, causing all first switch sub-units 211 and all signal transfer units 220 to remain turned off, and all second switch sub-units 212 to remain turned on. The connection between the p^{th}-stage first register output terminal and the (p+1)^{th}-stage first register input terminal is cut off, and the (p+1)^{th}-stage first register input terminal is connected to an auxiliary turn-off signal. The (p+1)^{th}-stage scan signal SCANp+1 outputs cutoff potential.

From the scan time of the (p+1)^{th} row of sub-pixels to before the phase of the scan time hq of the q^{th} row of sub-pixels, the transfer control signal SW5 remains at high potential, causing all signal transfer units 220 to remain turned off, to prevent the turn-on potential output by the stages of second shift registers 30 from being transmitted to the corresponding stages of first shift registers 10. Additionally, from the scan time of the (p+1)^{th} row of sub-pixels to before the phase of the scan time hq of the q^{th} row of sub-pixels, the (p+1)^{th}-stage to the (q−1)^{th}-stage scan signals all remain at the cutoff potential. Therefore, the on states of the first switch sub-units 211 and the second switch sub-units 212 do not affect the signal propagation process during this phase, and the potential of the first switch signal SW1 and the second switch signal SW2 can be set arbitrarily. Here, by way of example, a case is illustrated where the first switch signal SW1 remains at high potential, and the second switch signal SW2 remains at low potential, to reduce the potential jumps of the above two switch signals. With this configuration, continuous outputting of the cutoff potential by the (p+1)^{th}-stage to the q^{th}-stage first shift registers can be achieved.

During the phase of the scan time hq of the q^{th} row of sub-pixels, the first switch signal SW1 remains at high potential, the second switch signal SW2 jumps to high potential, and the transfer control signal SW5 jumps to low potential, causing all first switch sub-units 211 and all second switch sub-units 212 to turn off, and all signal transfer units 220 to turn on. The corresponding signal transfer unit transmits the output signal OUTq of the q^{th}-stage second shift register to the (q+1)^{th}-stage first shift register, re-providing a start signal to the (q+1)^{th}-stage first shift register.

From the scan time of the (q+1)^{th} row of sub-pixels to the end of the current frame, the first switch signal SW1 remains at low potential, the second switch signal SW2 remains at high potential, and the transfer control signal SW5 remains at high potential, causing all first switch sub-units 211 to remain turned on, and all second switch sub-units 212 and all signal transfer units 220 to remain turned off. The shift transmission of the turn-on potential of the scan signal can be achieved between the (q+1)^{th}-stage and the n^{th}-stage first shift registers.

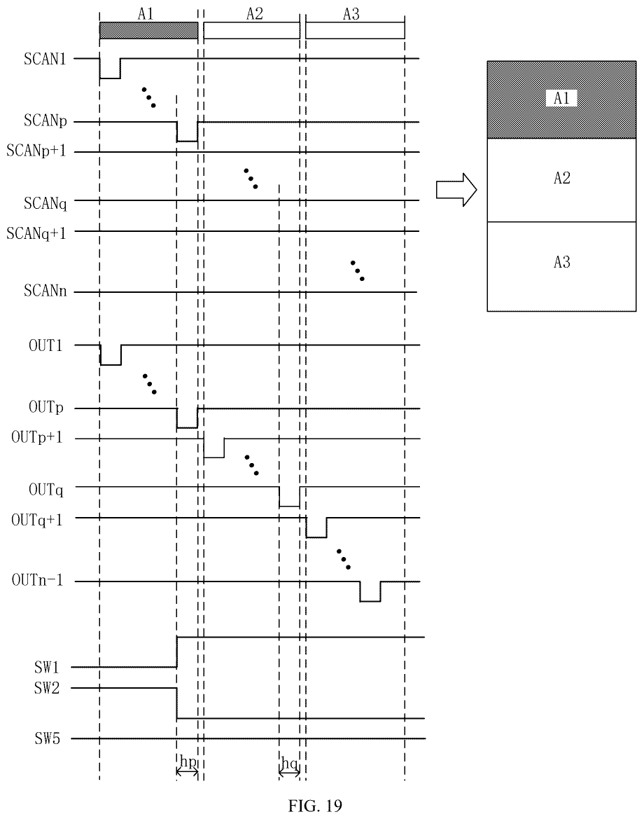

With reference to FIG. 19, in this display frame, each row of sub-pixels in the first sub-active area A1 are in an active frame, while each row of sub-pixels in the second sub-active area A2 and the third sub-active area A3 are in an idle frame. Low-potential pulses are present in the output signals OUT1 to OUTn−1 of all stages of second shift registers.

Before the phase of the scan time hp of the p^{th} row of sub-pixels, the first switch signal SW1 remains at low potential, the second switch signal SW2 remains at high potential, while the transfer control signal SW5 remains at high potential, causing all first switch sub-units 211 to remain turned on, and all second switch sub-units 212 and all signal transfer units 220 to remain turned off. The shift transmission of the turn-on potential of the scan signal can be achieved between the 1^{st}-stage and the p^{th}-stage first shift registers.

During the phase of the scan time hp of the p^{th} row of sub-pixels, the first switch signal SW1 jumps to high potential, the second switch signal SW2 jumps to low potential, and the transfer control signal SW5 remains at high potential, causing all first switch sub-units 211 and all signal transfer units 220 to remain turned off, and all second switch sub-units 212 to remain turned on. The connection between the p^{th}-stage first register output terminal and the (p+1)^{th}-stage first register input terminal is cut off, and the (p+1)^{th}-stage first register input terminal is connected to an auxiliary turn-off signal. The (p+1)^{th}-stage scan signal SCANp+1 outputs cutoff potential.

From the phase of the scan time of the (p+1)^{th} row of sub-pixels to the end of the current frame, the transfer control signal SW5 remains at high potential, causing all signal transfer units 220 to remain turned off, to prevent the turn-on potential output by the stages of second shift registers 30 from being transmitted to the corresponding stages of first shift registers 10. Additionally, since the (p+1)^{th}-stage scan signal SCANp+1 has output the cutoff potential, in this phase, the on states of the first switch sub-units 211 and the second switch sub-units 212 do not affect the signal propagation process during this phase, and the potential of the first switch signal SW1 and the second switch signal SW2 can be set arbitrarily. Here, by way of example, a case is illustrated where the first switch signal SW1 remains at high potential, and the second switch signal SW2 remains at low potential, to reduce the potential jumps of the above two switch signals. With this configuration, continuous outputting of the cutoff potential by the (p+1)^{th}-stage to the n^{th}-stage first shift registers can be achieved.

In practical applications, by adjusting the order and numbers of the aforementioned three types of display frames, various combinations of partitions and display frequencies can be achieved. By adjusting the potential jump time of the switch signals, the partition positions for multi-frequency display on the display panel can be adjusted. For example, adjusting the jump moment at which the first switch signal SW1 transitions from low to high and the second switch signal SW2 transitions from high to low in FIG. 18 forward is equivalent to shifting the partition position between the first sub-active area A1 and the second sub-active area A2 upward.

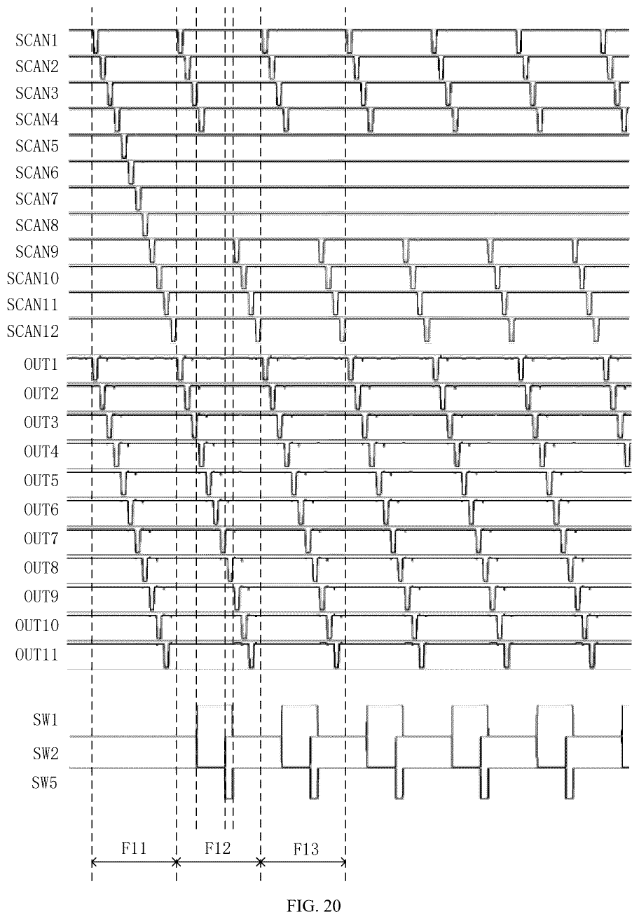

To verify the feasibility of the above scheme, the inventor has conducted a simulation of the operational process of the first scan driving circuit. For the simulation result, reference can be made to FIG. 20. As shown in FIG. 20, taking n=12, p=4, and q=8 as an example, the output signals OUT1 to OUT11 of the 1^{st}-stage to the 11^{th}-stage second shift registers maintain high-frequency refreshing. The display frame F11 may correspond to the display state in FIG. 17, in which the scan signals SCAN1 to SCAN12 are sequentially refreshed in this display frame. The display frames F12 and F13, and subsequent display frames may correspond to the display state in FIG. 18, in which the scan signals SCAN1 to SCAN4 contain low-potential pulses, and can thus control the 1^{st} to 4^{th} rows of sub-pixels to maintain high-frequency refreshing; the scan signals SCAN5 to SCAN8 remain at high potential during one frame of display, and can thus control the 5^{th} to 8^{th} rows of sub-pixels to remain in the idle frame; and the scan signals SCAN9 to SCAN12 return to the state of containing low-potential pulses, and can thus control the 9^{th} to 12^{th} rows of sub-pixels to maintain high-frequency refreshing.

On the basis of the above implementations, optionally, the control signals may be input from the mainboard of the terminal apparatus and enter the screen body via the driver IC. When the high and low potential ranges of the control signals meet the requirements for turning on and off the switch sub-units and signal transfer units, the control signals can directly enter the screen body; and when the high and low potential ranges of the control signals do not meet the requirements, the control signals can be converted by the driver IC before entering the screen body and provided to the cascade control modules. The mainboard of the terminal apparatus may have the capability of detecting the information of each frame of image to determine the display state of the display panel during each frame of display image and the refresh frequency corresponding to each sub-active area.

The above implementations exemplarily describe the functional processes of the functional modules in the display driving circuit. Below, the possible structures of the functional modules are explained.

With continued reference to FIG. 4, in one embodiment, the first switch sub-unit 211 includes a second transistor T2, where a gate of the second transistor T2 is connected to a first switch signal SW1, a first electrode of the second transistor T2 is electrically connected to a corresponding current-stage first register output terminal 12, and a second electrode of the second transistor T2 is electrically connected to a corresponding next-stage first register input terminal 11. In this embodiment, the first switch sub-unit 211 is configured to include one transistor, making it simple in structure and easy to implement.

With continued reference to FIG. 4, in one embodiment, the second switch sub-unit 212 includes a third transistor T3, where a gate of the third transistor T3 is connected to a second switch signal SW2, a first electrode of the third transistor T3 is connected to an auxiliary turn-off signal VD, and a second electrode of the third transistor T3 is electrically connected to a corresponding next-stage first register input terminal 11. In this embodiment, the second switch sub-unit 212 is configured to include one transistor, making it simple in structure and easy to implement.

With continued reference to FIG. 4, in one embodiment, the signal transfer unit 220 includes: a first transistor T1, where a gate of the first transistor T1 is connected to the transfer control signal SW5, a first electrode of the first transistor T1 is connected to the start control signal SC, and a second electrode of the first transistor T1 is electrically connected to a corresponding next-stage first register input terminal 11. In this embodiment, the signal transfer unit 220 is configured to include one transistor, making it simple in structure and easy to implement.

On the basis of the aforementioned implementations, optionally, the second shift registers 30 may be configured to have the same structure as the first shift registers 10. This ensures that the output process of the second shift registers 30 matches that of the first shift registers 10, thereby guaranteeing the reliability of the turn-on pulses provided by the second shift registers 30 to the next-stage first shift registers 10. In addition, during design, the structure of the first shift registers 10 can be directly replicated for the second shift registers 30, and the control signals connected to the first shift registers 10 can be reused, thereby reducing design complexity. Alternatively, since the output signals of the second shift registers 30 only need to be provided to the first shift registers 10 as start signals and are not used to drive sub-pixels, the second shift registers 30 may adopt a relatively simple structure to streamline the overall structure of the first scan driving circuit, which facilitates the implementation of narrow bezels.

By way of example, as shown in FIG. 16, the display panel is provided with: a first clock signal line configured to transmit a first clock signal CLK1; a second clock signal line configured to transmit a second clock signal CLK2; a first potential signal line configured to transmit a first potential signal VGH; a second potential signal line configured to transmit a second potential signal VGL; a first switch signal line configured to transmit a first switch signal SW1; a second switch signal line configured to transmit a second switch signal SW2; and a third switch signal line configured to transmit a transfer control signal SW5. All stages of first shift registers 10 are connected to the second potential signal VGL and the first potential signal VGH; and two adjacent stages of first shift registers 10 are alternately electrically connected to the first clock signal line and the second clock signal line, respectively. Taking two adjacent stages of first shift registers 10 being respectively the first-stage first shift register 10 and the second-stage first shift register 10 as an example, two adjacent stages of first shift registers 10 being alternately electrically connected to the first clock signal line and the second clock signal line specifically means that in the case where CLK1 serves as the first clock signal for the first-stage first shift register 10 and CLK2 serves as the second clock signal for the first-stage first shift register 10, CLK1 serves as the second clock signal for the second-stage first shift register 10 and CLK2 serves as the first clock signal for the second-stage first shift register 10; and all stages of second shift registers 30 are alternately electrically connected to the first clock signal line and the second clock signal line in the same order as the stages of first shift registers 10.

By way of example, the first potential signal VGH may be a high potential signal, and the second potential signal VGL may be a low potential signal. In an exemplary implementation, the turn-on potential of the scan signal is low potential, then as shown in FIG. 16, the first potential signal VGH may be reused as the auxiliary turn-off signal, and the first electrode of the third transistor T3 may be electrically connected to the first potential signal line. In another exemplary implementation, the turn-on potential of the scan signal is high potential, then the second potential signal VGL may be reused as the auxiliary turn-off signal, and the first electrode of the third transistor T3 may be electrically connected to the second potential signal line.

When the turn-on potential of the scan signal differs in level, in addition to the potential of the auxiliary turn-off signal needing to change accordingly, the structures of the first shift register and the second shift register also need to be adjusted accordingly, which will be described separately below.

In one embodiment, the turn-on potential of the scan signal is low potential. The structures of the modules in the display driving circuit under this condition are described below.

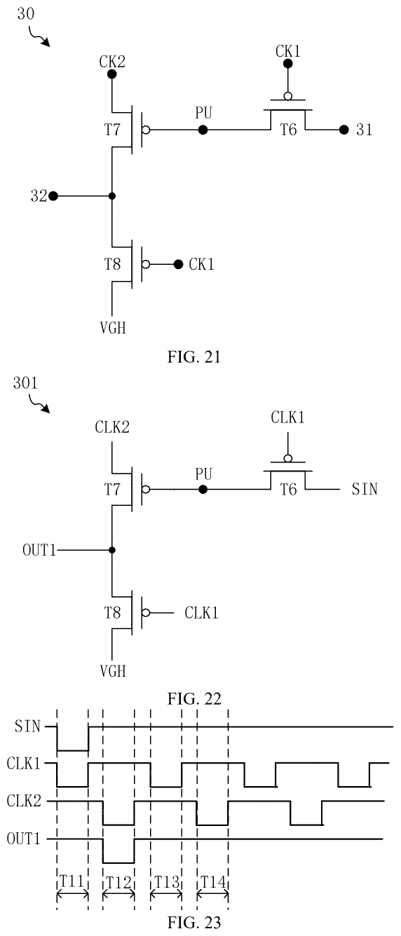

FIG. 21 is a schematic diagram of a structure of a second shift register according to an embodiment of the present application. With reference to FIG. 21, in one embodiment, the second shift register 30 includes: a first clock terminal CK1 and a second clock terminal CK2. First clock terminals CK1 and second clock terminals CK2 of two adjacent stages of second shift registers 30 can be alternately connected to the first clock signal line and the second clock signal line.

The second shift register 30 includes: a sixth transistor T6, a seventh transistor T7, and an eighth transistor T8. A gate of the sixth transistor T6 is electrically connected to the first clock terminal CK1 of the second shift register 30, a first electrode of the sixth transistor T6 is electrically connected to a second register input terminal 31, and a second electrode of the sixth transistor T6 is electrically connected to a gate of the seventh transistor T7, a first electrode of the seventh transistor T7 is electrically connected to the second clock terminal CK2 of the second shift register 30, and a second electrode of the seventh transistor T7 is separately electrically connected to a first electrode of the eighth transistor T8 and a second register output terminal 32, and a gate of the eighth transistor T8 is electrically connected to the first clock terminal CK1 of the second shift register 30, and a second electrode of the eighth transistor T8 is connected to the first potential signal VGH.

Since the first clock terminal CK1 and the second clock terminal CK2 of each stage of second shift register 30 are alternately connected to the first clock signal line and the second clock signal line, for explanatory convenience, the operational process of the second shift register will be described below by taking the 1^{st}-stage second shift register 301 as an example.

FIG. 22 is a schematic diagram of a structure of a 1^{st}-stage second shift register according to an embodiment of the present application. With reference to FIG. 22, in the 1^{st}-stage second shift register 301, the first clock terminal is connected to the first clock signal CLK1, and the second clock terminal is connected to the second clock signal CLK2.

FIG. 23 is a schematic diagram of a driving timing sequence of a second shift register according to an embodiment of the present application. With combined reference to FIGS. 22 and 23, by way of example, both the first clock signal CLK1 and the second clock signal CLK2 are clock signals whose potential alternately switches between VGH and VGL. Taking the output process of the 1^{st}-stage second shift register 301 as an example, the driving process of the second shift register includes the following phases.

First phase T11: The scan input signal SIN and the first clock signal CLK1 are at low potential, while the second clock signal CLK2 is at high potential. The sixth transistor T6 is turned on, allowing the low potential of the scan input signal SIN to be transmitted through the sixth transistor T6 to an intermediate node PU (i.e., the gate of the seventh transistor T7), thereby controlling the seventh transistor T7 to turn on, allowing the high potential of the second clock signal CLK2 to be output via the seventh transistor T7. At the same time, the low potential of the first clock signal CLK1 controls the eighth transistor T8 to turn on, enabling the first potential signal VGH to be output via the eighth transistor T8. Therefore, during this phase, the output signal OUT1 is at high potential.

Second phase T12: The scan input signal SIN and the first clock signal CLK1 are at high potential, while the second clock signal CLK2 is at low potential. The sixth transistor T6 and the eighth transistor T8 are turned off. The intermediate node PU remains at the low potential from the previous phase, controlling the seventh transistor T7 to turn on and output the low potential of the second clock signal CLK2. Therefore, during this phase, the output signal OUT1 is at low potential.

Third phase T13: The first clock signal CLK is at low potential, while the scan input signal SIN and the second clock signal CLK2 are at high potential. The sixth transistor T6 is turned on, allowing the high potential of the scan input signal SIN to be transmitted through the sixth transistor T6 to the intermediate node PU, thereby controlling the seventh transistor T7 to turn off. At the same time, the low potential of the first clock signal CLK1 controls the eighth transistor T8 to turn on, enabling the first potential signal VGH to be output via the eighth transistor T8. Therefore, during this phase, the output signal OUT1 is at high potential.

Fourth phase T14: The scan input signal SIN and the first clock signal CLK1 are at high potential, while the second clock signal CLK2 is at low potential. The sixth transistor T6 and the eighth transistor T8 are turned off. The intermediate node PU remains at the high potential from the previous phase, controlling the seventh transistor T7 to turn off, so that the output signal OUT1 remains at the high potential from the previous phase.

During subsequent phases, the processes of the third phase T13 and the fourth phase T14 are repeated, until the scan input signal SIN transitions to low potential again.

From the above analysis, it can be seen that during the second phase T12 and the fourth phase T14, the potential of the intermediate node PU is floating, and during the fourth phase T14, the potential of the second register output terminal 32 is floating. To ensure stable potential of the above two nodes, the inventor has made structural improvements to the aforementioned second shift register 30.

FIG. 24 is a schematic diagram of a structure of another second shift register according to an embodiment of the present application. Still taking the 1^{st}-stage second shift register 301 as an example, with reference to FIG. 24, on the basis of the aforementioned implementations, optionally, the second shift register further includes: a first capacitor C1 and a second capacitor C2, where the first capacitor C1 is connected between the gate and the second electrode of the seventh transistor T7, a first terminal of the second capacitor C2 is connected to the first potential signal VGH, and a second terminal of the second capacitor C2 is electrically connected to the second register output terminal.

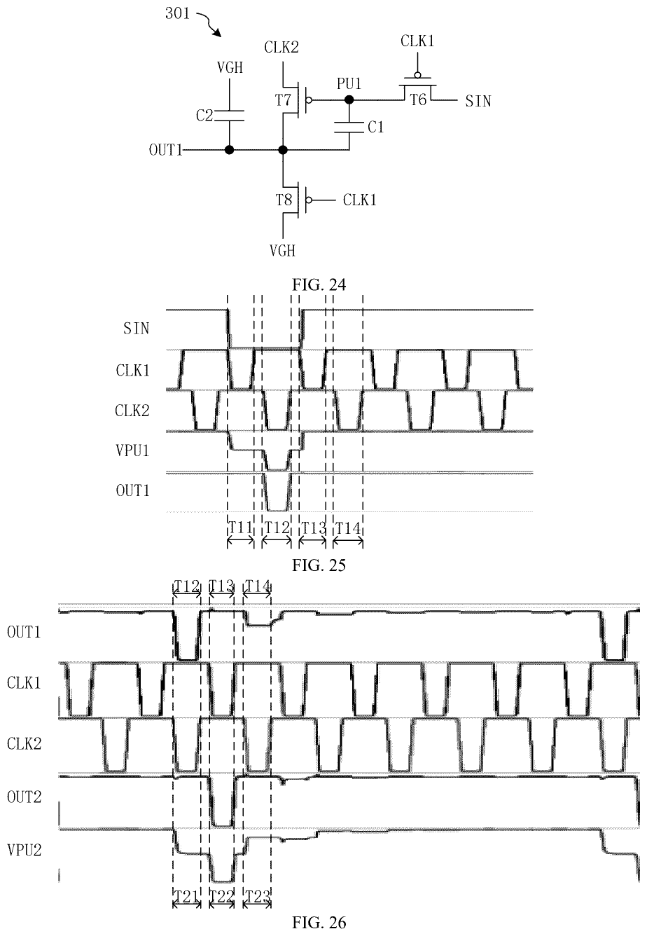

In this embodiment, two capacitors are added on the basis of FIG. 22. Utilizing the storage and coupling effects of the capacitors, stable output of the second shift register can be ensured. The following analysis is conducted in combination with simulation results in FIG. 25. With reference to FIG. 25, in the simulation verification, by way of example, a pulse width of the scan input signal SIN is set to be greater than that in FIG. 23. The low potential of the scan input signal SIN in FIG. 25 extends into the second phase T12. However, since the sixth transistor T6 is not turned on during the second phase T12, this adjustment does not affect the output of the second shift register in each phase, and the aforementioned analysis process is still applicable. Below, the focus is on analyzing potential changes at characteristic points during each phase.

During the first phase T11, the intermediate node VPU1 is charged to VPU1=VGL−Vth, where Vth represents a threshold voltage of the sixth transistor T6.

During the second phase T12, at the moment when the second clock signal CLK2 transitions to low potential, this low potential is output through the seventh transistor T7, causing the output signal OUT1 to change from high potential to low potential. Due to the coupling effect of the first capacitor C1, the potential change of the output signal OUT1 is coupled to the intermediate node VPU1, causing the potential VPU1 of the intermediate node VPU1 to jump downward to VGL−Vth−(VGH−VGL)*C1/Ctotal, thereby fully turning on the seventh transistor T7. Here, Ctotal includes all capacitances connected to the intermediate node VPU1, encompassing both the first capacitor C1 and parasitic capacitances of the sixth transistor T6 and the seventh transistor T7. At the moment when the second clock signal CLK2 transitions to high potential again, this high potential is output through the seventh transistor T7, causing the output signal OUT1 to change from low potential to high potential. Similarly, due to the coupling effect of the first capacitor C1, the potential change of the output signal OUT1 is again coupled to the intermediate node VPU1, causing the potential VPU1 of the intermediate node VPU1 to rebound upward.

During the third phase T13, the intermediate node VPU1 transitions to high potential, and the output signal OUT1 is at high potential. The first capacitor C1 stores the potential across the terminals thereof, and the second capacitor C2 stores the potential across the terminals thereof.

During the fourth phase T14, both the intermediate node VPU1 and the second register output terminal are floating. The potential of the intermediate node VPU1 is maintained by the first capacitor C1, while the potential of the second register output terminal is maintained jointly by the first capacitor C1 and the second capacitor C2.

It should be noted that the first capacitor C1 is primarily configured for potential coupling during the second phase T12. When both the intermediate node VPU1 and the second register output terminal are floating, since both terminals of the first capacitor C1 are at floating potential, the potential change at any floating node may be coupled to the other floating node through the first capacitor C1. Therefore, the first capacitor C1 provides limited effectiveness in maintaining potential stability. The arrangement of the second capacitor C2 can serve to assist in maintaining the potential stability of the second register output terminal and can indirectly ensure the potential stability of the intermediate node VPU1.

It should also be noted that, in this embodiment, the first terminal of the second capacitor C2 is exemplarily connected to the first potential signal VGH, which, however, is not intended to limit the present application. In other implementations, the first terminal of the second capacitor C2 may be connected to any other fixed potential signal (direct-current signal), for example, to a second potential signal VGL.

From FIG. 25, it can be seen that the simulation output results align with the principle. In practical operations, the capacitance values of the two capacitors can be set according to requirements, with the capacitance values of both capacitors configurable within the range of 50 fF to 200 fF, for example, 50 fF, 80 fF, 100 fF, 150 fF, 180 fF, or 200 fF.

Furthermore, during experimental verification of the driving process for the second shift register illustrated in FIG. 21, waveforms shown in FIG. 26 are obtained. With reference to FIG. 26, taking the output process of the 2^{nd}-stage second shift register as a reference, the output signal OUT1 of the 1^{st}-stage second shift register serves as the input signal for the 2^{nd}-stage second shift register. The driving process of the 2^{nd}-stage second shift register differs from the driving process of the 1^{st}-stage second shift register by 1/2 clock signal period. That is to say, the second phase T12 of the 1^{st}-stage second shift register corresponds to the first phase T21 of the 2^{nd}-stage second shift register, and so forth. From FIG. 21, it can be seen that during the output process of the 2^{nd}-stage second shift register, the potential VPU2 of the intermediate node PU thereof is unstable, where an abnormal potential pull-down occurs during the third phase T23. Analysis reveals the cause of this phenomenon as follows.

During the third phase T23 of the 2^{nd}-stage second shift register, the intermediate node of the 2^{nd}-stage second shift register requires charging to high potential with the input signal of the 2^{nd}-stage second shift register (i.e., the output signal of the 1^{st}-stage second shift register). However, this phase corresponds to the fourth phase T14 of the 1^{st}-stage second shift register, during which the 1^{st}-stage second register output terminal is floating and there is no voltage input. Consequently, the potential of the output signal OUT1 from the 1^{st}-stage second shift register decreases in this phase, and the potential VPU2 of the intermediate node of the 2^{nd}-stage second shift register fails to reach target high potential.

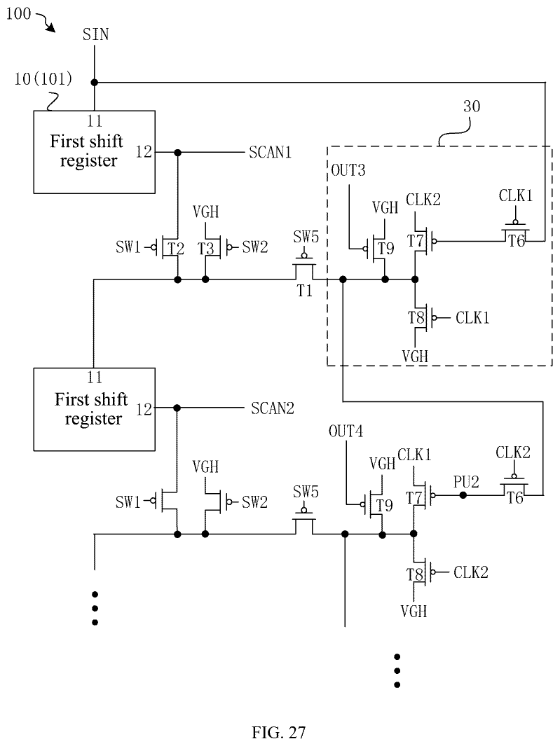

To address the above problem, the inventor has proposed an improvement scheme. FIG. 27 is a schematic diagram of a structure of a further second shift register according to an embodiment of the present application. With reference to FIG. 27, on the basis of the circuit shown in FIG. 21, optionally, the second shift register 30 may be further provided with: a ninth transistor T9, where a first electrode of the ninth transistor T9 is connected to the first potential signal VGH, a second electrode of the ninth transistor T9 is electrically connected to the current-stage second register output terminal, and a gate of the n^{th}-stage ninth transistor T9 is electrically connected to the (n+2)^{th}-stage second register output terminal, where n is a positive integer. For example, the gate of the 1^{st}-stage ninth transistor T9 is connected to the output signal OUT3 of the 3^{rd}-stage second shift register. It should be noted that when the next-stage first shift register to which the i^{th}-stage first shift register is connected is an (i+a)^{th}-stage first shift register, correspondingly, the gate of the n^{th}-stage ninth transistor T9 is electrically connected to the (n+2a)^{th}-stage second register output terminal.

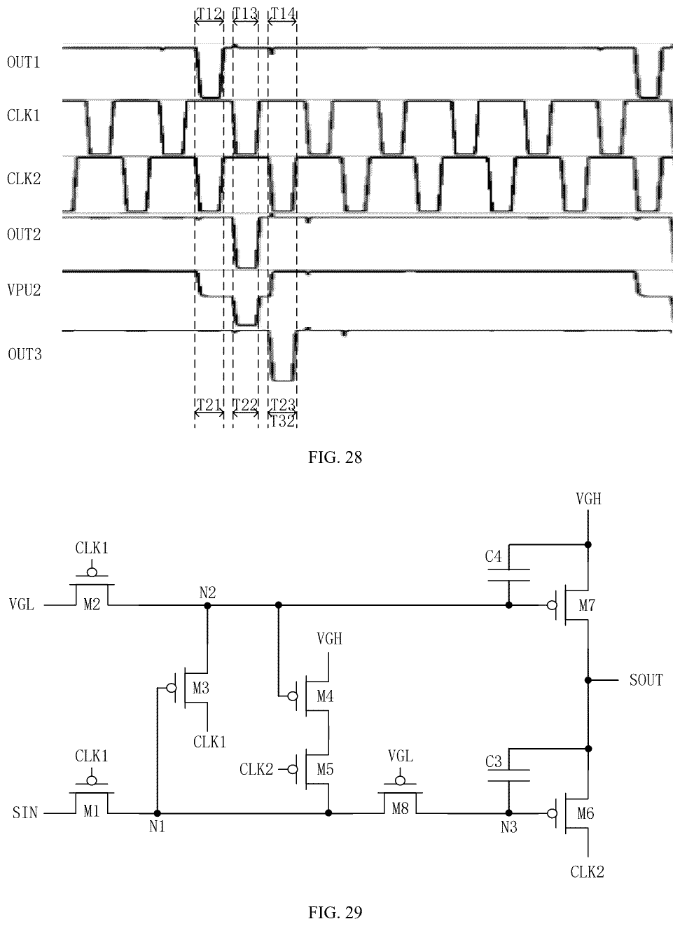

For simulation waveforms for the improvement scheme, reference can be made to FIG. 28. As shown in FIG. 28, the abnormal potential pull-down at the intermediate node during the third phase has been effectively mitigated. The operational principle is analyzed as follows.

During the third phase T23 of the 2^{nd}-stage second shift register, the intermediate node of the 2^{nd}-stage second shift register requires charging to high potential with the output signal of the 1^{st}-stage second shift register. This phase corresponds to the second phase T32 of the 3^{rd}-stage second shift register, during which the output signal OUT3 of the 3^{rd}-stage second shift register is at low potential, which can control the ninth transistor T9 in the 1^{st}-stage second shift register to turn on, ensuring that the 1^{st}-stage second register output terminal is no longer floating but is stably input with high potential. Consequently, during this phase, the first potential signal VGH passes through the ninth transistor T9 in the 1^{st}-stage second shift register and the sixth transistor T6 in the 2^{nd}-stage second shift register to charge the intermediate node PU2 of the 2^{nd}-stage second shift register, allowing the potential VPU2 of the intermediate node in the 2^{nd}-stage second shift register to reach the target high potential. Therefore, this improvement scheme can significantly enhance the potential stability of the second register output terminal and the intermediate node.

It should be noted that in this embodiment, to effectively provide control signals to the ninth transistors T9 in the 1^{st}-stage to the n^{th}-stage second shift registers, two redundant stages of second shift registers 30 may be configured, i.e., a total of n+2 stages of second shift registers 30 are provided. Herein, the (n+1)^{th}-stage second shift register 30 is configured to provide the control signal to the (n−1)^{th}-stage ninth transistor T9, while the (n+2)^{th}-stage second shift register 30 is configured to provide the control signal to the n^{th}-stage ninth transistor T9. By way of example, the (n+1)^{th}-stage and the (n+2)^{th}-stage second shift registers 30 may not be provided with the ninth transistor T9, but instead adopt the structure shown in FIG. 24 to stabilize the potential at the output terminal of the second shift register.

It should also be noted that the improvement scheme in FIG. 27 is also applicable to the scheme in FIG. 24. On the basis of the circuit in FIG. 21, by adding both the first capacitor C1 and the second capacitor C2, as well as adding the ninth transistor T9, the potential at both the intermediate node and the output terminal of the second shift register can be more effectively stabilized.

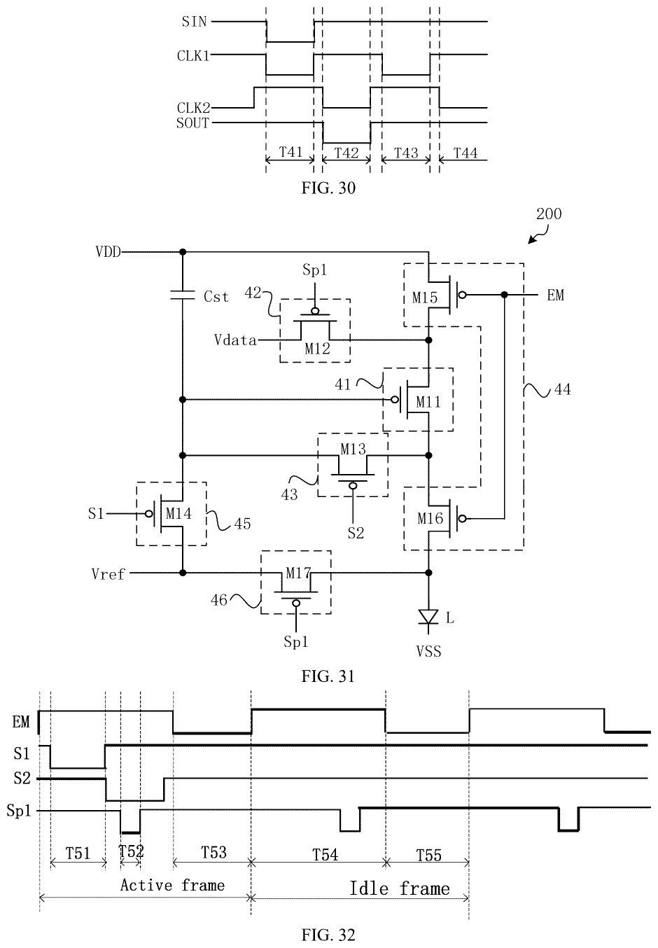

FIG. 29 is a schematic diagram of a structure of a shift register according to an embodiment of the present application. With reference to FIG. 29, in one embodiment, the shift register may include eight transistors and two capacitors, and the shift register can serve as a first shift register and/or a second shift register. This shift register includes: transistors M1 to M8, and capacitors C3 and C4. FIG. 30 is a schematic diagram of a driving timing sequence of a shift register according to an embodiment of the present application. With reference to FIGS. 29 and 30, the driving process of the shift register includes the following phases.

First phase T41: The first clock signal CLK1 and the scan input signal SIN are at low potential, while the second clock signal CLK2 is at high potential. The transistors M1 and M2 are turned on, and the transistor M5 is cut off; the transistor M8 is turned on; the low potential of the scan input signal SIN is transmitted through the transistor M1 to the node N1, causing the transistor M3 to be turned on; the low potential of the first clock signal CLK1 is transmitted through the transistor M3 to the node N2, and at the same time, the low potential of the second potential signal VGL is transmitted through the transistor M2 to the node N2, causing the transistor M7 to be turned on; the high potential of the first potential signal VGH is transmitted through the transistor M7 to the output terminal of the shift register; the low potential of the node N1 is transmitted through the transistor M8 to the node N3, causing the transistor M6 to be turned on; and the high potential of the second clock signal CLK2 is transmitted through the transistor M6 to the output terminal of the shift register. As a result, during the first phase T31, the output signal SOUT of the shift register is at high potential.

Second phase T42: The second clock signal CLK2 is at low potential, while the first clock signal CLK1 and the scan input signal SIN are both at high potential. The transistors M1 and M2 are cut off, and the transistor M5 is turned on; and the transistor M8 remains turned on. Due to the storage effect of the capacitor C3, the node N3 remains at the low potential from the previous phase, causing the transistor M6 to be turned on; and the low potential of the node N3 is transmitted through the transistor M8 to the node N1, causing transistor M3 to be turned on. The high potential of the first clock signal CLK1 is transmitted through the transistor M3 to the node N2, causing the transistor M7 to be cut off. The low potential of the second clock signal CLK2 is output through the transistor M6, and the output signal SOUT is at low potential.

Third phase T43: The first clock signal CLK1 is at low potential, while the second clock signal CLK2 and the scan input signal SIN are both at high potential. The transistors M1 and M2 are turned on, and the transistor M5 is cut off; and the transistor M8 is turned on. The high potential of the scan input signal SIN is transmitted through the transistor M1 to the node N1, causing the transistor M3 to be cut off; and the high potential of the node N1 is transmitted through the transistor M8 to the node N3, causing the transistor M6 to be cut off. The low potential of the second potential signal VGL is transmitted through the transistor M2 to the node N2, causing the transistor M7 to be turned on; and the high potential of the first potential signal VGH is output through the transistor M7, and the output signal SOUT is at high potential.

Fourth phase T44: The second clock signal CLK2 is at low potential, while the first clock signal CLK1 and the scan input signal SIN are both at high potential. The transistors M1 and M2 are cut off, and the transistor M5 is turned on; and the transistor M8 is turned on. Due to the storage effect of the capacitor C4, the node N2 remains at the low potential from the previous phase, causing the transistors M4 and M7 to be turned on. The high potential of the first potential signal VGH is transmitted through the transistors M4, M5, and M8 to the node N3, causing the transistor M6 to be cut off. The high potential of the first potential signal VGH is output through the transistor M7, and the output signal SOUT is at high potential.

By repeating the third phase T43 and the fourth phase T44, the output signal SOUT remains at high potential until the scan input signal SIN becomes low potential again.

The aforementioned embodiments exemplarily provide the structure and operational process of a shift register capable of outputting a low-potential turn-on pulse. The following provides illustrations of the structure of the pixel driver circuit that applies such a scan signal, and the connection method between the pixel driver circuit and the first scan driving circuit.

FIG. 31 is a schematic diagram of a structure of a pixel driver circuit according to an embodiment of the present application. With reference to FIG. 31, in one embodiment, the pixel driver circuit 200 includes: a driving module 41, a data writing module 42, a threshold compensation module 43, and a light emission control module 44. The driving module 41, the light emission control module 44, and the light-emitting device L are connected in series, the data writing module 42 is electrically connected to the first terminal of the driving module 41, and the threshold compensation module 43 is connected between the control terminal and the second terminal of the driving module 41. The control terminal of the data writing module 42 is connected to a third control signal Sp1, the control terminal of the threshold compensation module 43 is connected to a second control signal S2, and the control terminal of the light emission control module 44 is connected to a light emission control signal EM. Additionally, the pixel driver circuit 200 may further include: a first reset module 45 electrically connected to the control terminal of the driving module 41; a second reset module 46 electrically connected to the anode of the light-emitting device L; and a storage capacitor Cst electrically connected to the control terminal of the driving module 41. The control terminal of the first reset module 45 is connected to a first control signal S1, and the control terminal of the second reset module 46 is connected to the third control signal Sp1.

By way of example, the driving module 41 includes a driving transistor M11, the data writing module 42 includes a transistor M12, the threshold compensation module 43 includes a transistor M13, the light emission control module 44 includes transistors M15 and M16, the first reset module 45 includes a transistor M14, and the second reset module 46 includes a transistor M17, constituting a pixel driver circuit including seven transistors and one capacitor. The gates of the transistors serve as the control terminals of the respective functional modules. By way of example, all the transistors may be P-type transistors, fabricated using low temperature poly-silicon (LTPS) technology, constituting an LTPS pixel driver circuit.

FIG. 32 is a schematic diagram of a driving timing sequence of a pixel driver circuit according to an embodiment of the present application. With combined reference to FIGS. 31 and 32, the driving process of the pixel driver circuit includes the following phases.

Initialization phase T51: The first control signal S1 is at low potential, while the third control signal Sp1, the second control signal S2, and the light emission control signal EM are at high potential. The transistor M14 is turned on, and an initialization voltage signal Vref is transmitted to the gate of the driving transistor M11 through the transistor M14, initializing the gate of the driving transistor M11.

Data writing phase T52: The third control signal Sp1 and the second control signal S2 are at low potential, while the first control signal S1 and the light emission control signal EM are at high potential. Both the transistors M12 and M13 are turned on. A data voltage Vdata is transmitted to the gate of the driving transistor M11 via the transistors M12, the driving transistor M11, and the transistor M13, until a gate voltage of the driving transistor M11 reaches Vdata+Vth1, at which point the driving transistor M11 is turned off. Here, Vth1 is a threshold voltage of the driving transistor M11. Meanwhile, the transistor M17 is turned on, and the initialization voltage signal Vref is transmitted to the anode of the light-emitting device L through the transistor M17, initializing the anode of the light-emitting device L.

First light emission phase T53: The light emission control signal EM is at low potential, while the first control signal S1, the third control signal Sp1, and the second control signal S2 are at high potential. Both the transistors M15 and M16 are turned on. The driving transistor M11 generates a driving current based on a first power signal VDD and the gate potential of the driving transistor M11, driving the light-emitting device L to emit light.

The aforementioned driving process represents a driving timing sequence of the pixel driver circuit 200 in an active frame. When the driving process of the pixel driver circuit 200 further includes an idle frame, the driving process in the idle frame includes the following phases.

Non-light emission phase T54: The light emission control signal EM is at high potential. Both the transistors M15 and M16 are turned off. A connection path between the driving transistor M11 and the light-emitting device L is disconnected, and the light-emitting device L does not emit light. During this phase, the turn-on pulse of the third control signal Sp1 may be present, enabling the resetting of the anode of the light-emitting device L and the first electrode of the driving transistor M11 to correct the characteristic drift of the light-emitting device L and the driving transistor M11 during the light emission process.

Second light emission phase T55: The light emission control signal EM is at low potential. Both the transistors M15 and M16 are turned on. The driving transistor M11 generates a driving current based on the first power signal VDD and the potential of the gate of the driving transistor M11 that is saved in the active frame, driving the light-emitting device L to emit light.

As can be seen from the above analysis, when the pixel driver circuit 200 is displaying at a high frequency, the first control signal S1, the third control signal Sp1, the second control signal S2, and the light emission control signal EM are all high-frequency signals. When the pixel driver circuit 200 is displaying at a low frequency, the first control signal S1 and the second control signal S2 are low-frequency signals, the light emission control signal EM is a high-frequency signal, and the third control signal Sp1 can be either a low-frequency signal or a high-frequency signal.

The first scan driving circuit according to the embodiments of the present application is configured to control the data writing process of each pixel driver circuit. The scan signal output by each stage of first shift register can serve as the second control signal S2 required in the pixel driver circuit, and is configured to control the process of writing the data voltage to the gate of the driving transistor M11. Other control signals required by the pixel driver circuit can be separately provided by other scan driving circuits in the display panel. For example, the display driving circuit may further include: a second scan driving circuit configured to provide the third control signal Sp1 to each row of pixel driver circuits; a light emission control driving circuit configured to provide the light emission control signal EM to each row of pixel driver circuits; and a third scan driving circuit configured to provide the first control signal S1 to each row of pixel driver circuits. Among these, since the frequency of the first control signal S1 varies with the display refresh frequency, the third scan driving circuit may adopt the same structure as the first scan driving circuit. By way of example, since the first control signal S1 and the second control signal S2 have the same turn-on potential and turn-on pulse width, as well as the operational frequency, and for the same row of sub-pixels, the only difference between the two control signals lies in the duration during which the turn-on potential is applied, in the display driving circuit, the first scan driving circuit can be reused as the third scan driving circuit to reduce the size of the panel bezel. For example, different stages of first shift registers can be connected to the same row of pixel driver circuits, where the preceding stage of first shift register provides the first control signal S1 to the pixel driver circuit, while the subsequent stage of first shift register provides the second control signal S2 to the pixel driver circuit.

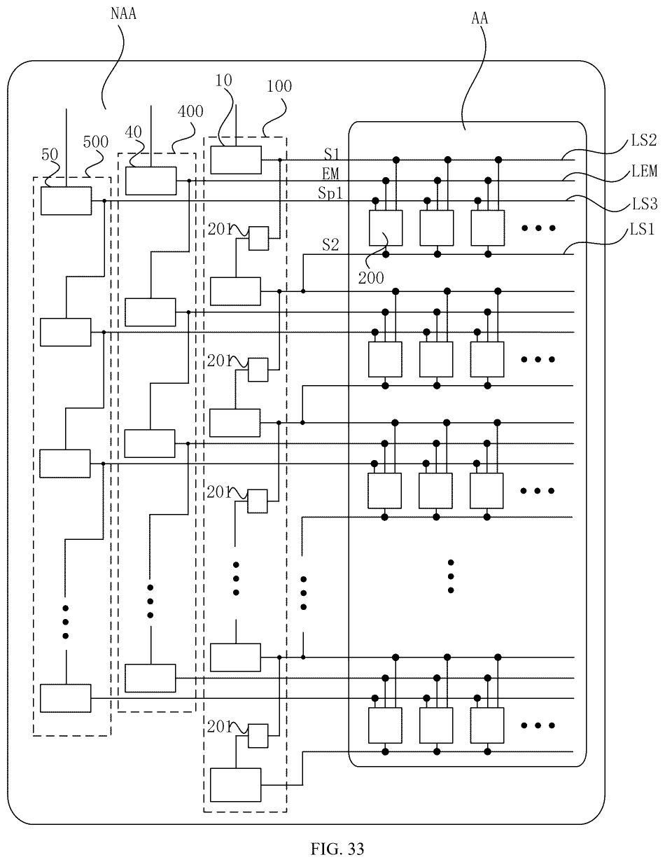

FIG. 33 is a schematic diagram of a structure of a further display panel according to an embodiment of the present application. Below, with reference to FIG. 33, the connection relationship that the first scan driving circuit may have with the pixel driver circuit when it is applied to the display panel will be described. With reference to FIG. 33, in one embodiment, in the display panel, the pixel driver circuits 200 are arranged in the active area AA of the display panel, and the scan driving circuits and the light emission control driving circuits 400 are arranged in the non-active area NAA of the display panel. The driving circuits in the non-active area NAA provide control signals to the rows of pixel driver voltages 200 through signal lines.

By way of example, the display panel is provided with a first scan driving circuit 100, a second scan driving circuit 500, and a light emission control driving circuit 400. The second scan driving circuit 500 includes a plurality of stages of third shift registers 50 arranged in cascade. The light emission control driving circuit 400 includes a plurality of stages of fourth shift registers 40 arranged in cascade. The scan signal output terminal of the j^{th}-stage first shift register 10 is electrically connected to the second scan line LS2 connected to the j^{th} row of pixel driver circuits 200, and the scan signal output terminal of the (j+b)^{th}-stage first shift register 10 is electrically connected to the first scan line LS1 connected to the j^{th} row of pixel driver circuits 200. Here, j and b are both positive integers, and in FIG. 33, b=1, for example. The j^{th}-stage third shift register 50 is electrically connected to the third scan line LS3 connected to the j^{th} row of pixel driver circuits 200, and the j^{th}-stage fourth shift register 40 is electrically connected to a light emission control signal line LEM connected to the j^{th} row of pixel driver circuits 200. The first scan lines LS1 respectively provide the second control signal S2 to each row of pixel driver circuits 200, the second scan lines LS2 respectively provide the first control signal S1 to each row of pixel driver circuits 200, the third scan lines LS3 respectively provide the third control signal Sp1 to each row of pixel driver circuits 200, and the light emission control signal lines LEM respectively provide the light emission control signal EM to each row of pixel driver circuits 200.

The aforementioned embodiments exemplarily provide an applicable scenario for the first shift register to output a scan signal of a low-potential turn-on pulse, which, however, is not intended to limit the present application. In another implementation, optionally, the turn-on potential of the scan signal output by the first shift register may also be a high potential. The applicable scenario for this case will be explained below.

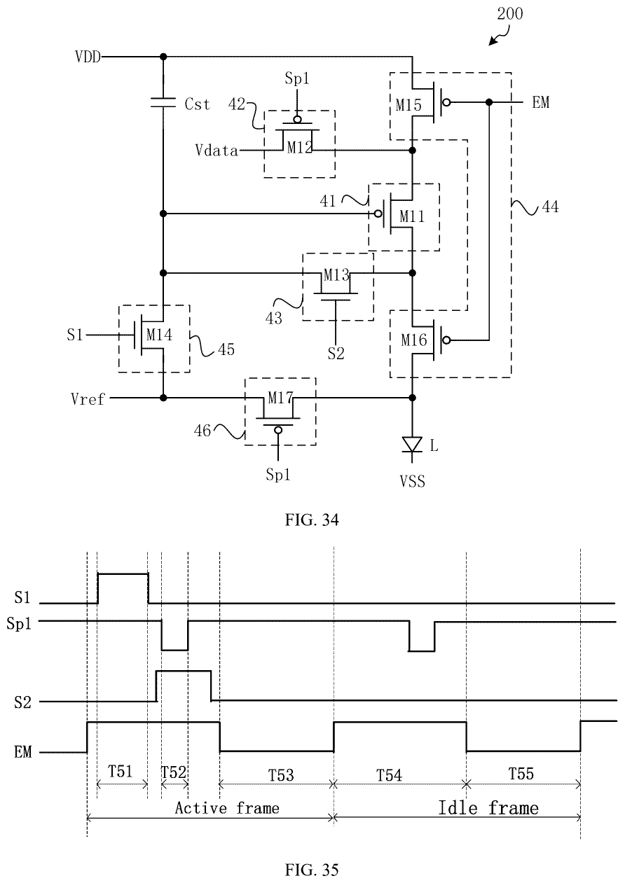

FIG. 34 is a schematic diagram of a structure of another pixel driver circuit according to an embodiment of the present application. With reference to FIG. 34, the difference from the pixel driver circuit 200 in FIG. 31 lies in that, in FIG. 34, the transistor M13 in the threshold compensation module 43 and the transistor M14 in the first reset module 45 are replaced with N-type transistors, for example, Indium Gallium Zinc Oxide (IGZO) transistors, forming an LTPO pixel driver circuit. Based on the advantages of low leakage current and good long-range uniformity of the N-type IGZO transistors, this pixel driver circuit can suppress current leakage at the gate of the driving transistor M11 during the light emission process, which is beneficial for achieving display at lower refresh frequencies.

FIG. 35 is a schematic diagram of a driving timing sequence of another pixel driver circuit according to an embodiment of the present application. FIG. 35 differs from FIG. 32 only in that both the first control signal S1 and the second control signal S2 are changed to the inverted signals for the corresponding control signals in FIG. 32, that is, the turn-on potential of the first control signal S1 and the turn-on potential of the second control signal S2 are both high potential. The above analysis of the driving process for the pixel driver circuit is also applicable to this pixel driver circuit and will not be repeated. Furthermore, this pixel driver circuit can still adopt the same connection relationship with the scan driving circuits as that shown in FIG. 33, which will not be repeated.

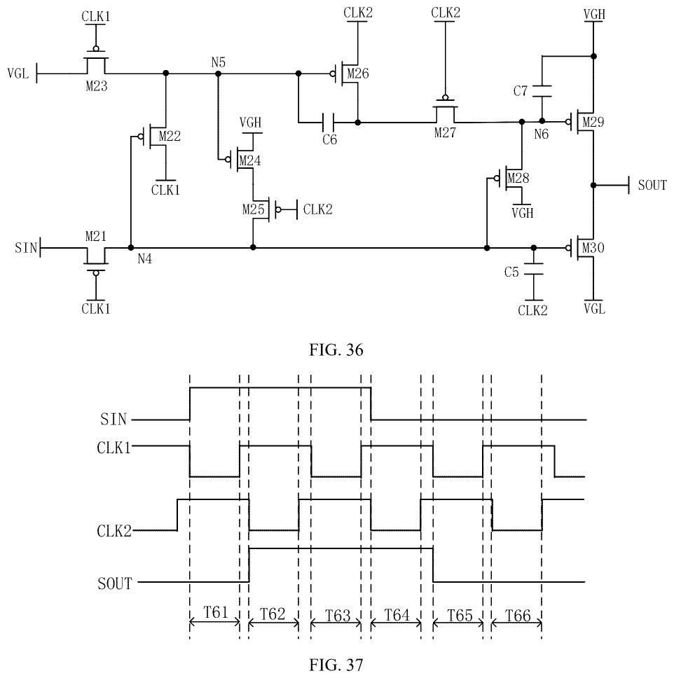

FIG. 36 is a schematic diagram of a structure of another shift register according to an embodiment of the present application. With reference to FIG. 36, in one embodiment, the shift register may adopt a circuit architecture including ten transistors and three capacitors to generate an output signal whose turn-on potential is high potential. This shift register can serve as a first shift register and/or a second shift register. By way of example, this shift register includes: transistors M21 to M30, and capacitors C5 to C7. FIG. 37 is a schematic diagram of a driving timing sequence of another shift register according to an embodiment of the present application. With reference to FIGS. 36 and 37, the driving process of the shift register includes the following phases.

First phase T61: The first clock signal CLK1 is at low potential, while the second clock signal CLK2 and the scan input signal SIN are at high potential. The transistors M21 and M23 are turned on, and the transistors M25 and M27 are cut off; and the high potential of the scan input signal SIN is transmitted through the transistor M21 to the node N4, causing the transistors M22, M28, and M30 to be cut off. The low potential of the second potential signal VGL is transmitted through the transistor M23 to the node N5, causing the transistors M24 and M26 to be turned on. Due to the storage effect of the capacitor C7, the node N6 remains at the high potential from the previous phase, causing the transistor M29 to be cut off. As a result, the output signal SOUT remains at the low potential from the previous phase.

Second phase T62: The second clock signal CLK2 is at low potential, while the first clock signal CLK1 and the scan input signal SIN are at high potential. The transistors M25 and M27 are turned on, and the transistors M21 and M23 are cut off. Due to the storage effect of the capacitor C6, the node N5 remains at the low potential from the previous phase, causing the transistors M24 and M26 to be turned on. The high potential of the first potential signal VGH is transmitted through the transistors M24 and M25 to the node N4, causing the transistors M22, M28, and M30 to be cut off. The low potential of the second clock signal CLK2 is transmitted through the transistors M26 and M27 to the node N6, causing the transistor M29 to be turned on. The first potential signal VGH is transmitted through the transistor M29, causing the output signal SOUT to be at high potential.

Third phase T63: The first clock signal CLK1 is at low potential, while the second clock signal CLK2 and the scan input signal SIN are at high potential. The transistors M21 and M23 are turned on, and the transistors M25 and M27 are cut off. The high potential of the scan input signal SIN is transmitted through the transistor M21 to the node N4, causing the transistors M22, M28, and M30 to be cut off. The low potential of the second potential signal VGL is transmitted through the transistor M23 to the node N5, causing the transistors M24 and M26 to be turned on. Due to the storage effect of the capacitor C7, the node N6 remains at the low potential from the previous phase, causing the transistor M29 to remain turned on and the output signal SOUT to remain at high potential.

Fourth phase T64: The first clock signal CLK1 is at high potential, while the second clock signal CLK2 and the scan input signal SIN are at low potential. The transistors M21 and M23 are cut off, and the transistors M25 and M27 are turned on. Due to the storage effect of the capacitor C6, the node N5 remains at the low potential from the previous phase, causing the transistors M24 and M26 to be turned on. The high potential of the first potential signal VGH is transmitted through the transistors M24 and M25 to the node N4, causing the transistors M22, M28, and M30 to be cut off. The low potential of the second clock signal CLK2 is transmitted through the transistors M26 and M27 to the node N6, causing the transistor M29 to be turned on. The high potential of the first potential signal VGH is transmitted through the transistor M29, causing the output signal SOUT to remain at high potential.

Fifth phase T65: The second clock signal CLK2 is at high potential, while the first clock signal CLK1 and the scan input signal SIN are at low potential. The transistors M21 and M23 are turned on, and the transistors M25 and M27 are cut off. The low potential of the scan input signal SIN is transmitted through the transistor M21 to the node N4, causing the transistors M22, M28, and M30 to be turned on. The low potential of the first clock signal CLK1 is transmitted through the transistor M22 to the node N5, causing the transistors M24 and M26 to be turned on. However, due to the cutoff of the transistor M27, the low potential of the node N5 cannot be transmitted to the node N6. The high potential of the first potential signal VGH is transmitted through the transistor M28 to the node N6, causing the transistor M29 to be cut off. The low potential of the second potential signal VGL is transmitted through the transistor M30, causing the output signal SOUT to become low potential.

Sixth phase T66: The first clock signal CLK1 is at high potential, while the second clock signal CLK2 and the scan input signal SIN are at low potential. The transistors M25 and M27 are turned on. Due to the coupling effect of the capacitor C5, as the second clock signal CLK2 becomes low potential, the potential of the node N4 changes to low potential lower than that in the fifth phase 25, causing the transistors M22, M28, and M30 to remain turned on; the high potential of the first clock signal CLK1 is transmitted through the transistor M22 to the node N5, causing the node N5 to become high potential; and the high potential of the first potential signal VGH is transmitted through the transistor M28 to the node N6, causing the transistor M29 to remain cut off. Compared with the previous phase, although the transistor M27 has been turned on in this phase, since the potential of the node N5 has become high potential, the transistor M26 is turned off and will not pull down the potential of the node N6, so that the node N6 can remain at high potential. The low potential of the second potential signal VGL is transmitted through the transistor M30, causing the output signal SOUT to remain at low potential.

Subsequently, the fifth phase T65 and the sixth phase T66 are repeated, and the shift register continuously outputs low potential. This continues until the scan input signal SIN becomes high potential again.

It should be noted that, in the shift register circuit according to this embodiment, by adjusting the turn-on pulse width of the scan input signal SIN, the correspondence between the scan input signal SIN and the output signal SOUT can be adjusted. An exemplary illustration is provided below for application scenarios of different pulse widths.

In one embodiment, by controlling the turn-on pulse width of the input signal SIN to be the same as the turn-on pulse width of the first clock signal CLK1, the turn-on pulses of the scan input signal SIN and the output signal SOUT can be made non-overlapping. Thus, the scan driving circuits and the pixel driver circuits can adopt the connection method as shown in FIG. 33, and the scan driving circuits can provide the driving waveforms shown in FIG. 35 to the pixel driver circuits.

In another implementation, optionally, when the turn-on pulse width of the scan input signal SIN contains a plurality of turn-on pulses of the first clock signal CLK1, the turn-on pulses of the scan input signal SIN and the output signal SOUT overlap. As shown in FIG. 37, when the turn-on pulse width of the scan input signal SIN contains two turn-on pulses of the first clock signal CLK1, in order to provide the driving waveform shown in FIG. 35 to the pixel driver circuit, the output signal of the j^{th}-stage first register may be used as the first control signal S1 for the j^{th} row of pixel driver circuits, and the output signal of the (j+3)^{th}-stage first register may be used as the second control signal S2 for the j^{th} row of pixel driver circuits.

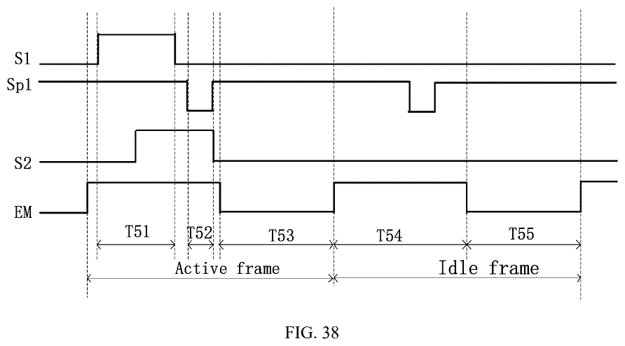

In a further implementation, optionally, the case where the turn-on pulses of the scan input signal SIN and the output signal SOUT overlap shown in FIG. 37 is also applicable to the connection method as shown in FIG. 33. In this case, a driving timing sequence provided by the scan driving circuits to the pixel driver circuits is as shown in FIG. 38. Unlike in FIG. 35, in FIG. 38, the turn-on pulses of the first control signal S1 and the second control signal S2 overlap. With combined reference to FIGS. 34 and 38, during the overlap of the turn-on pulses of the first control signal S1 and the second control signal S2, both the transistors M13 and M14 are turned on. After being transmitted through the transistor M14 to the gate of the driving transistor M11, the initialization voltage signal Vref continues to be transmitted through the transistor M13 to the second electrode of the driving transistor M11, thereby achieving initialization of the second electrode of the driving transistor M11 and improving the initialization effect. In addition, the data writing phase T52 is still performed after the initialization phase T51 ends, that is, the turn-on pulse of the third control signal Sp1 is located after the end of the turn-on pulse of the first control signal S1 and overlaps with the turn-on pulse of the second control signal S2.

It should be noted that the structures of the shift registers according to the aforementioned embodiments are not intended to limit the present application. In other implementations, the first shift register and the second shift register may be implemented using shift register circuits with any structure in the related art.

An embodiment of the present application further provides a display device, which includes a display driving circuit according to any of the embodiments of the present application. By way of example, the display device includes a display panel according to any of the above embodiments, where the display driving circuit is disposed in the display panel. The display panel can be a display panel of a type such as an active-matrix organic light-emitting diode panel or a micro light-emitting diode display panel. The display device can be any product or component having a display function, such as a mobile phone, a tablet computer, a television, or a monitor.

It should be understood that the steps may be reordered, added, or deleted using the various forms of processes illustrated above. For example, the steps recorded in the present application may be performed in parallel, sequentially, or in a different order, provided that desired results of the embodiments of the present application can be achieved, which are not limited herein.

What is claimed is:

1. A display driving circuit, comprising: a first scan driving circuit,
the first scan driving circuit comprising:
a plurality of first shift registers arranged in cascade, the first shift register comprising a first register input terminal and a first register output terminal; and
at least one first cascade control module,
one of the at least one first cascade control module comprising a first cascade control unit, wherein the first cascade control unit is connected between two of the first shift registers, the two of the first shift registers comprise a current-stage first shift register and a next-stage first shift register, the current-stage first shift register comprise a current-stage first register output terminal, the next-stage first shift register comprise a next-stage first register input terminal; and the first cascade control unit is configured to control a connection state between the current-stage first register output terminal and the next-stage first register input terminal; and
the one of the at least one first cascade control module further comprising a signal transfer unit, wherein a control terminal of the signal transfer unit is applied a transfer control signal, an input terminal of the signal transfer unit is applied a start control signal, and an output terminal of the signal transfer unit is electrically connected to the next-stage first register input terminal; and the signal transfer unit is configured to transmit the start control signal to the next-stage first register input terminal in response to the transfer control signal.

2. The display driving circuit according to claim 1, wherein the start control signal comprises a reference signal having fixed potential; and the signal transfer unit is configured to transmit the reference signal to the next-stage first register input terminal in response to the transfer control signal.

3. The display driving circuit according to claim 1, wherein the start control signal comprises a pulse signal, the control terminal of the signal transfer unit is electrically connected to the input terminal of the signal transfer unit, and the transfer control signal is reused as the start control signal.

4. The display driving circuit according to claim 1, wherein the first cascade control unit comprises a first switch sub-unit, a control terminal of the first switch sub-unit being applied a first switch signal, a first terminal of the first switch sub-unit being electrically connected to the current-stage first register output terminal, and a second terminal of the first switch sub-unit being electrically connected to the next-stage first register input terminal, wherein
the transfer control signal and the first switch signal are opposite in phase; and the start control signal comprises: a pulse signal, and the signal transfer unit is configured to transmit the pulse signal to the next-stage first register input terminal in response to the transfer control signal.

5. The display driving circuit according to claim 1, wherein the current-stage first shift register and the next-stage first shift register are respectively an i^{th}-stage first shift register and an (i+a)^{th}-stage first shift register, where i and a are both positive integers, wherein in a case where the i^{th}-stage first shift register outputs a cutoff potential of an i^{th}-stage scan signal and the (i+a)^{th}-stage first shift register outputs a turn-on potential of an (i+a)^{th}- stage scan signal, during a phase when the i^{th}-stage first shift register outputs the cutoff potential of the i^{th}-stage scan signal, the first cascade control unit is configured to cut off a connection between the i^{th}-stage first shift register and the (i+a)^{th}-stage first shift register, and the signal transfer unit is configured to transmit the start control signal to a first register input terminal of the (i+a)^{th}-stage first shift register in response to the transfer control signal; and
in a case where the i^{th}-stage first shift register outputs a turn-on potential of the i^{th}-stage scan signal and the (i+a)^{th}-stage first shift register outputs a cutoff potential of the (i+a)^{th}-stage scan signal, during a phase when the i^{th}-stage first shift register outputs the turn-on potential of the i^{th}-stage scan signal, the first cascade control unit is configured to cut off the connection between the i^{th}-stage first shift register and the (i+a)^{th}-stage first shift register, and the signal transfer unit is configured to be turned off in response to the transfer control signal.

6. The display driving circuit according to claim 1, wherein the first cascade control unit is connected between an m^{th}-stage first shift register and an (m+a)^{th}-stage first shift register, wherein m and a are both positive integers; and the (m+a)^{th}-stage first shift register is a next-stage first shift register corresponding to the m^{th}-stage first shift register; and
the first scan driving circuit further comprises at least one second cascade control module, one of the at least one second cascade control module comprising a second cascade control unit, the second cascade control unit being connected between a k^{th}-stage first shift register and a (k+a)^{th}-stage first shift register, wherein k is a positive integer less than m, and the (k+a)^{th}-stage first shift register is a next-stage first shift register corresponding to the k^{th}-stage first shift register.

7. The display driving circuit according to claim 6, wherein a partition position for reduced-frequency display of display panel is determined based on a position where the second cascade control module is provided; and a partition position for increased-frequency display of the display panel is determined based on a position where the first cascade control module is provided.

8. The display driving circuit according to claim 6, wherein
the signal transfer unit comprises a first transistor, wherein a gate of the first transistor is applied the transfer control signal, a first electrode of the first transistor is applied the start control signal, and a second electrode of the first transistor is electrically connected to an (m+a)^{th}-stage first register input terminal of the (m+a)^{th}-stage first shift register; and
the first cascade control unit comprises a first switch sub-unit, the first switch sub-unit comprising a second transistor, wherein a gate of the second transistor is configured a first switch signal, a first electrode of the second transistor is electrically connected to an m^{th}-stage first register output terminal of the m^{th}-stage first shift register, and a second electrode of the second transistor is electrically connected to the (m+a)^{th}-stage first register input terminal.

9. The display driving circuit according to claim 8, wherein in a case where the m^{th}-stage first shift register outputs a cutoff potential of an m^{th}-stage scan signal and the (m+a)^{th}-stage first shift register outputs a turn-on potential of an (m+a)^{th}-stage scan signal, during a phase when the m^{th}-stage first shift register outputs the cutoff potential of the m^{th}-stage scan signal, the second transistor is configured to disconnect the m^{th}-stage first register output terminal from the (m+a)^{th}-stage first register input terminal in response to the first switch signal, and the first transistor is configured to transmit the start control signal to the (m+a)^{th}-stage first register input terminal in response to the transfer control signal.

10. The display driving circuit according to claim 8, wherein the first cascade control unit further comprises a second switch sub-unit, the second switch sub-unit comprising a third transistor, wherein a gate of the third transistor is applied a second switch signal, a first electrode of the third transistor is applied an auxiliary turn-off signal, and a second electrode of the third transistor is electrically connected to the (m+a)^{th}-stage first register input terminal; and
in a case where the m^{th}-stage first shift register outputs a cutoff potential of an m^{th}-stage scan signal and the (m+a)^{th}-stage first shift register outputs a turn-on potential of an (m+a)^{th}-stage scan signal, during a phase when the m^{th}-stage first shift register outputs the cutoff potential of the m^{th}-stage scan signal, the third transistor disconnects the auxiliary turn-off signal from the (m+a)^{th}-stage first register input terminal in response to the second switch signal.

11. The display driving circuit according to claim 8, wherein the second cascade control unit comprises a third switch sub-unit, the third switch sub-unit comprising a fourth transistor, wherein a gate of the fourth transistor is applied a third switch signal, a first electrode of the fourth transistor is electrically connected to a k^{th}-stage first register output terminal of the k^{th}-stage first shift register, and a second electrode of the fourth transistor is electrically connected to a (k+a)^{th}-stage first register input terminal of the (k+a)^{th}-stage first shift register; and
the second cascade control unit further comprises a fourth switch sub-unit, the fourth switch sub-unit comprising a fifth transistor, wherein a gate of the fifth transistor is applied a fourth switch signal, a first electrode of the fifth transistor is applied an auxiliary turn-off signal, and a second electrode of the fifth transistor is electrically connected to the (k+a)^{th}-stage first register input terminal.

12. The display driving circuit according to claim 11, wherein in a case where the k^{th}-stage first shift register outputs a turn-on potential of a k^{th}-stage scan signal and the (k+a)^{th}-stage first shift register outputs a cutoff potential of a (k+a)^{th}-stage scan signal, during a phase when the k^{th}-stage first shift register outputs the turn-on potential of the k^{th}-stage scan signal, the fourth transistor is configured to disconnect the k^{th}-stage first register output terminal from the (k+a)^{th}-stage first register input terminal in response to the third switch signal, and the fifth transistor is configured to transmit the auxiliary turn-off signal to the (k+a)^{th}-stage first register input terminal in response to the fourth switch signal.

13. The display driving circuit according to claim 11, wherein the first switch signal is reused as the third switch signal, and the transfer control signal is reused as the fourth switch signal;
or
the first cascade control unit further comprises a second switch sub-unit, the second switch sub-unit comprising a third transistor, wherein a gate of the third transistor is applied a second switch signal, a first electrode of the third transistor is applied the auxiliary turn-off signal, and a second electrode of the third transistor is electrically connected to the (m+a)^{th}-stage first register input terminal; and the first switch signal is reused as the third switch signal, and the second switch signal is reused as the fourth switch signal.

14. The display driving circuit according to claim 1, wherein the at least one first cascade control module comprises a plurality of first cascade control modules, each of the first cascade control modules being disposed between two corresponding first shift registers among at least part of the first shift registers; and
the first scan driving circuit further comprises a plurality of second shift registers arranged in cascade, wherein at least part of the second shift registers are arranged respectively corresponding to the at least part of the first shift registers; and
the second shift register comprises a second register input terminal and a second register output terminal, wherein
an input terminal of the signal transfer unit is electrically connected to a corresponding second register output terminal among the at least part of the second shift registers, and a corresponding start control signal is output to the input terminal of the corresponding signal transfer unit through the second register output terminal among the at least part of the second shift registers.

15. The display driving circuit according to claim 14, wherein
a partition position for increased-frequency display is determined based on jump time of a transfer control signal;
the second shift registers are arranged respectively corresponding to the first shift registers; and a first-stage first register input terminal and a first-stage second register input terminal are both applied a scan input signal; and
each of the signal transfer units is configured to be turned on in response to the same transfer control signal, and a pulse width of the transfer control signal is greater than or equal to that of an output signal of each of the second shift registers.

16. The display driving circuit according to claim 14, wherein the second shift register comprises a sixth transistor, a seventh transistor and an eighth transistor, wherein a gate of the sixth transistor is electrically connected to a first clock terminal of the second shift register, a first electrode of the sixth transistor is electrically connected to the second register input terminal, and a second electrode of the sixth transistor is electrically connected to a gate of the seventh transistor, a first electrode of the seventh transistor is electrically connected to a second clock terminal of the second shift register, and a second electrode of the seventh transistor is electrically connected to the second register output terminal, and a gate of the eighth transistor is electrically connected to the first clock terminal of the second shift register, a first electrode of the eighth transistor is electrically connected to the second register output terminal, and a second electrode of the eighth transistor is applied a first potential signal;
the second shift register further comprises a first capacitor and a second capacitor, wherein the first capacitor is connected between the gate and the second electrode of the seventh transistor, a first terminal of the second capacitor is applied the first potential signal, and a second terminal of the second capacitor is electrically connected to the second register output terminal; and
the second shift register further comprises a ninth transistor, wherein a first electrode of the ninth transistor is applied the first potential signal, a second electrode of the ninth transistor is electrically connected to the second register output terminal, and in a case where the second electrode of the ninth transistor is electrically connected to an n^{th}-stage second register output terminal, a gate of the ninth transistor is electrically connected to an (n+2a)^{th}-stage second register output terminal, where n is a positive integer.

17. The display driving circuit according to claim 14, wherein
the signal transfer units are all turned on in response to a same transfer control signal;
the first cascade control modules comprise first cascade control units, wherein the first cascade control units comprise first switch sub-units, the first switch sub-units comprising second transistors, wherein gates of the second transistors are all applied the same first switch signal, first electrodes of the second transistors are electrically connected to corresponding current-stage first register output terminals, and second electrodes of the second transistors are electrically connected to corresponding next-stage first register input terminals;
the first cascade control units further comprise second switch sub-units, the second switch sub-units comprising third transistors, wherein gates of the third transistors are all applied the same second switch signal, first electrodes of the third transistors are all applied the same auxiliary turn-off signal, and second electrodes of the third transistors are electrically connected to corresponding next-stage first register input terminals; and
the signal transfer units comprise first transistors, wherein gates of the first transistors are all applied the same transfer control signal, first electrodes of the first transistors are applied corresponding start control signals, and second electrodes of the first transistors are electrically connected to corresponding next-stage first register input terminals.

18. The display driving circuit according to claim 17, wherein
in a case where the first switch signal controls the second transistor to be turned on and the second switch signal controls the third transistor to be turned off, the transfer control signal controls the first transistor to be turned off, so that the first transistor does not transmit a corresponding start control signal to a next-stage first register input terminal corresponding to the first transistor, and a current-stage first register output terminal corresponding to the second transistor is electrically connected to the next-stage first register input terminal;
in a case where the first switch signal controls the second transistor to be turned off and the second switch signal controls the third transistor to be turned on, the transfer control signal controls the first transistor to be turned off, so that the first transistor does not transmit the start control signal to the next-stage first register input terminal corresponding to the first transistor, and the auxiliary turn-off signal is transmitted to a next-stage first register input terminal corresponding to the third transistor; and
in a case where the first switch signal controls the second transistor to be turned off and the second switch signal controls the third transistor to be turned off, the transfer control signal controls the first transistor to be turned on, and the first transistor outputs the corresponding start control signal to the next-stage first register input terminal corresponding to the first transistor.

19. The display driving circuit according to claim 1, further comprising a plurality of pixel driver circuits and a plurality of first scan lines, wherein the plurality of pixel driver circuits are arranged in an array, and each row of pixel driver circuits is electrically connected to at least one of the plurality of first scan lines; and first register output terminals in the first scan driving circuit are electrically connected to the first scan lines; the pixel driver circuit comprising: a driving module, a data writing module, a threshold compensation module, and a light emission control module, wherein the driving module is connected between the light emission control module and a light-emitting device, and the driving module is configured to generate a driving current;
the data writing module is electrically connected to a first terminal of the driving module, and the data writing module is configured to transmit a data voltage to the driving module; the threshold compensation module is connected between a control terminal and a second terminal of the driving module, and the threshold compensation module is configured to compensate for a threshold voltage of the driving module; and the first scan line is electrically connected to control terminals of threshold compensation modules in a corresponding row of pixel driver circuits; and
the pixel driver circuit further comprises a first reset module electrically connected to the control terminal of the driving module, the first reset module being configured to reset the control terminal of the driving module; and the display driving circuit further comprises: a plurality of second scan lines, the second scan lines being electrically connected to control terminals of first reset modules in corresponding rows of pixel driver circuits, wherein
first register output terminals in the first scan driving circuit are electrically connected to the second scan lines, wherein a second scan line connected to a j^{th} row of pixel driver circuits is electrically connected to a j^{th}-stage first register output terminal, and a first scan line connected to the j^{th} row of pixel driver circuits is electrically connected to a (j+b)^{th}-stage first register output terminal, wherein j and b are both positive integers.

20. The display driving circuit according to claim 1, wherein the signal transfer unit comprises a first transistor, wherein a gate of the first transistor is applied the transfer control signal, a first electrode of the first transistor is applied the start control signal, and a second electrode of the first transistor is electrically connected to a corresponding next-stage first register input terminal;
the first cascade control unit comprises a first switch sub-unit, the first switch sub-unit comprising a second transistor, wherein a gate of the second transistor is applied a first switch signal, a first electrode of the second transistor is electrically connected to a corresponding current-stage first register output terminal, and a second electrode of the second transistor is electrically connected to a corresponding next-stage first register input terminal; and
the first cascade control unit further comprises a second switch sub-unit, the second switch sub-unit comprising a third transistor, wherein a gate of the third transistor is applied a second switch signal, a first electrode of the third transistor is applied an auxiliary turn-off signal, and a second electrode of the third transistor is electrically connected to a corresponding next-stage first register input terminal.
